(19) United States
(12) Patent Application Publication
(10) Pub. No.: US 2026/0089682 A1
(43) Pub. Date: Mar. 26, 2026

(54) CONFIGURING USER EQUIPMENT WITH ROBUST PAGING

(71) Applicant: SHARP KABUSHIKI KAISHA, Sakai City (JP)

(72) Inventors: Ken Park, Cahtlamet, WA (US); Atsushi Ishii, Vancouver, WA (US)

(21) Appl. No.: 18/896,842

(22) Filed: Sep. 25, 2024

(51) Int. Cl. H04W 68/02; H04W 8/18

(52) U.S. Cl. CPC H04W 68/02; H04W 8/186

(57) ABSTRACT

A UE is configured with a first parameter indicating whether the UE is allowed to start robust paging function and a second parameter indicating the maximum number of consecutive legacy paging messages the UE has to fail to receive before the robust paging function is started. The UE's processor monitors a legacy paging occasion to receive a legacy paging message, determines that the number of consecutive legacy paging occasions that the UE fails to receive legacy paging messages has reached the value of the second parameter, starts the robust paging function after determining that the value of the first parameter indicates that the UE is allowed to start the robust paging function, and the number of consecutive legacy paging occasions that the UE fails to receive the legacy paging messages has reached the value of the second parameter, and monitors a robust paging occasion to receive a robust paging message.

### TECHNICAL FIELD

The technology generally relates to wireless communications, and more particularly, to mobile paging service.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems, such as improvements in the network mobility management.

### SUMMARY

In a first aspect of the present application, a user equipment (UE) is provided. The UE includes one or more non-transitory computer-readable media storing one or more computer-executable instructions for configuring the UE with different types of paging functions. The UE is configured with a first parameter indicating whether the UE is allowed to start a paging function of a second type that is different from a paging function of a first type, a second parameter indicating a maximum number of consecutive paging messages of the first type the UE has to fail to receive before the paging function of the second type is started, and a third parameter indicating a maximum number of consecutive paging messages of a second type the UE has to fail to receive before the paging function of the second type is stopped. The UE includes at least one processor coupled to the one or more non-transitory computer-readable media, and configured to execute the one or more computer-executable instructions to cause the UE to monitor, during the paging function of the first type, a paging occasion of the first type to receive a paging message of the first type; after failing to receive the paging message of the first type during the paging occasion of the first type, increment a number of consecutive paging occasions of the first type the UE fails to receive paging messages of the first type; determine that the number of consecutive paging occasions of the first type the UE fails to receive the paging messages of the first type has reached a value of the second parameter; start the paging function of the second type after determining that (i) a value of the first parameter indicates that the UE is allowed to start the paging function of the second type, and (ii) the number of consecutive paging occasions of the first type the UE fails to receive the paging messages of the first type has reached the value of the second parameter; and monitor, during the paging function of the second type, a paging occasion of the second type to receive a paging message of the second type.

In an implementation of the first aspect, the at least one processor is further configured to execute the one or more computer-executable instructions to cause the UE to: in a case that a paging message of the second type is received by the UE, retrieve a message identity index from the paging message of the second type, and retrieve a string identified by the message identity index; and in a case that the UE fails to receive a paging message of the second type during the paging occasion of the second type: increment the number of consecutive paging occasions of the second type during which the UE fails to receive paging messages of the second type, and stop the paging function of the second type in a case that the number of consecutive paging occasions of the second type during which the UE fails to receive the paging messages of the second type reaches a value of the third parameter.

In another implementation of the first aspect, the UE further includes a display. The at least one processor is further configured to execute the one or more computer-executable instructions to cause the UE to display the string identified by the message identity on the display of the UE.

In another implementation of the first aspect, the UE is further configured with a fourth parameter indicating whether the UE supports concurrent monitoring of the paging messages of the first and second types, and the at least one processor is further configured to execute the one or more computer-executable instructions to cause the UE to concurrently monitor for the paging messages of the first and second types in a case that the paging function of the second type is started, and the fourth parameter indicates that the UE supports the concurrent monitoring of the paging messages of the first and second types.

In another implementation of the first aspect, the at least one processor is further configured to execute the one or more computer-executable instructions to cause the UE to monitor for the paging messages of the first type and not monitor for the paging messages of the second type in a case that either a paging message of the first type is received, a paging message of the second type is received, or the number of consecutive paging occasions of the second type during which the UE fails to receive the paging messages of the second type reaches the value of the third parameter.

In another implementation of the first aspect, the UE is further configured with a fourth parameter indicating whether the UE supports concurrent monitoring of the paging messages of the first and second types, and the at least one processor is further configured to execute the one or more computer-executable instructions to cause the UE to monitor for the paging messages of the second type and not monitor for the paging messages of the first type in a case that the paging function of the second type is started, and the fourth parameter indicates that the UE does not support the concurrent monitoring of the paging messages of the first and second types.

In another implementation of the first aspect, the at least one processor is further configured to execute the one or more computer-executable instructions to cause the UE to monitor for the paging messages of the first type and not monitor for the paging messages of the second type in a case that either a paging message of the second type is received, or the number of consecutive paging occasions of the second type during which the UE fails to receive the paging messages of the second type reaches the value of the third parameter.

In another implementation of the first aspect, the at least one processor is further configured to execute the one or more computer-executable instructions to cause the UE to receive a downlink control information (DCI) message that includes a fourth parameter indicating a number of times a paging message of the second type is retransmitted during each paging occasion of the second type; identify several paging messages of the second type that are retransmitted during the paging occasion of the second type based on the fourth parameter; and aggregate a correctly decoded part of each of two or more paging messages of the several paging messages of the second type that are retransmitted during the paging occasion of the second type to construct a fully decoded paging message of the second type.

In another implementation of the first aspect, the UE is configured with a fourth parameter indicating a number of times a paging message of the second type is to be retransmitted during each paging occasion of the second type, the fourth parameter is configured to the UE either at a time of manufacturing the UE or through one of a radio resource control (RRC) message, a non-access-stratum (NAS) message, a system information block (SIB) message, or a medium access control (MAC) control element (CE) message, and the at least one processor is further configured to execute the one or more computer-executable instructions to cause the UE to identify several paging messages of the second type that is retransmitted during a paging occasion of the second type based on the fourth parameter; and aggregate a correctly decoded part of each of two or more paging messages of the several paging messages of the second type that is retransmitted during the paging occasion of the second type to construct a fully decoded paging message of the second type.

In another implementation of the first aspect, the first, second, and third parameters are configured to the UE at a time of manufacturing the UE.

In another implementation of the first aspect, the at least one processor is further configured to execute the one or more computer-executable instructions to cause the UE to receive the first, second, and third parameters prior to starting the paging function of the second type through one of an RRC message, a NAS message, a SIB message, or a MAC CE message.

In another implementation of the first aspect, the UE is further configured with a first type of 5th generation serving temporary mobile subscriber identity (5G-S-TMSI), and the at least one processor is further configured to execute the one or more computer-executable instructions to cause the UE to retrieve a second type of 5G-S-TMSI from each paging message of the second type; compare the first type of 5G-S-TMSI with the second type of 5G-S-TMSI; and determine that the paging message of the second type is targeted to the UE when the second type of 5G-S-TMSI is equal to the first type of 5G-S-TMSI.

In another implementation of the first aspect, the UE is further configured with a first type of 5G-S-TMSI. The first type of 5G-S-TMSI includes m bits, m being a non-zero integer, and the at least one processor is further configured to execute the one or more computer-executable instructions to cause the UE to retrieve a second type of 5G-S-TMSI from each paging message of the second type, the second type of 5G-S-TMSI includes n bits, n being a non-zero integer smaller than m; compare the second type of 5G-S-TMSI with a first n-bits of the first type of 5G-S-TMSI; and determine that the paging message of the second type is targeted to the UE when the second type of 5G-S-TMSI is equal to the first n-bits of the first type of 5G-S-TMSI.

In another implementation of the first aspect, the paging messages of the first type are identified by a radio network temporary identifier (RNTI) of the first type, the RNTI of the first type is a paging RNTI (P-RNTI), the paging messages of the second type are identified by a RNTI of the second type that is different from the P-RNTI, each paging message of the first type is received in a first physical downlink shared channel (PDSCH), the first PDSCH is identified by a DCI message of the first type, a cyclic redundancy check (CRC) of each DCI message of the first type is encoded with the P-RNTI, each paging message of the second type is received in a second PDSCH, the second PDSCH is identified by a DCI message of the second type, a CRC of each DCI message of the second type is encoded with the RNTI of the second type, and the at least one processor is further configured to execute the one or more computer-executable instructions to cause the UE to identify a DCI message as a DCI message of the first type comprising a paging message of the first type in a case that the CRC of the DCI message is decoded by the P-RNTI; and identify a DCI message as a DCI message of the second type comprising a paging message of the second type in a case that the CRC of the DCI message is decoded by the RNTI of the second type.

In a second aspect of the present application, a method of configuring a UE with different types of paging functions is provided. The method includes configuring a first parameter to the UE, the first parameter indicating whether the UE is allowed to start a paging function of a second type that is different from a paging function of a first type; configuring a second parameter to the UE, the second parameter indicating a maximum number of consecutive paging messages of a first type the UE fails to receive before the paging function of the second type is started; configuring a third parameter indicating a maximum number of consecutive paging messages of a second type the UE fails to receive before the paging function of the second type is stopped; monitoring, during the paging function of the first type, a paging occasion of the first type to receive a paging message of the first type; after failing to receive the paging message of the first type during the paging occasion of the first type, incrementing a number of consecutive paging occasions of the first type the UE fails to receive paging messages of the first type; determining that the number of consecutive paging occasions of the first type the UE fails to receive the paging messages of the first type has reached a value of the second parameter; starting the paging function of the second type after determining that (i) a value of the first parameter indicates that the UE is allowed to start the paging function of the second type, and (ii) the number of consecutive paging occasions of the first type the UE fails to receive the paging messages of the first type has reached the value of the second parameter; and monitoring, during the paging function of the second type, a paging occasion of the second type to receive a paging message of the second type.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagram illustrating an example of an NTN with an LEO satellite implementing a transparent payload at orbit 600 km, according to an example implementation of the present disclosure.

FIG. 2 is a schematic diagram illustrating another radio communication system, according to an example implementation of the present disclosure.

FIG. 3 is a state diagram illustrating the states of a UE's robust paging service, according to an example implementation of the present disclosure.

FIG. 4 is a flowchart illustrating an example method/process performed by a UE for initializing the robust paging service procedure, according to an example implementation of the present disclosure.

FIG. 5 is a flowchart illustrating an example method/process performed by a UE for tracking the legacy paging operations that may trigger the start of the robust paging operation, according to an example implementation of the present disclosure.

FIG. 6 is a flowchart illustrating an example method/process performed by a UE for tracking the robust paging operations that may trigger the end of the robust paging operation, according to an example implementation of the present disclosure.

FIG. 7 illustrates a table that includes an example of a RobustPage_RNTI, according to an example implementation of the present disclosure.

FIG. 8 illustrates a table that includes an example of DCI format 1_0 with CRC scrambled by RobustPage-RNTI, according to an example implementation of the present disclosure.

FIG. 9 illustrates a table that includes another example of DCI format 1_0 with CRC scrambled by RobustPage-RNTI, according to an example implementation of the present disclosure.

FIG. 10 illustrates a table that includes another example of DCI format 1_0 with CRC scrambled by RobustPage-RNTI, according to an example implementation of the present disclosure.

FIG. 11 is a flowchart illustrating an example method/process performed by a UE for configuring the UE with different types of paging functions, according to an example implementation of the present disclosure.

FIG. 12 is a flowchart illustrating an example method/process performed by a UE for configuring the UE to support paging functions of first and second types, according to an example implementation of the present disclosure.

FIG. 13 is a flowchart illustrating an example method/process performed by a UE for configuring the UE to support paging functions of first and second types, according to an example implementation of the present disclosure

FIG. 14 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system”and “network”herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present embodiment, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

In LTE/NR networks, paging frames and paging occasions are used to optimize the paging function and reduce the impact on network resources. Examples of some selected terms in the present disclosure are provided as follows.
Paging Frame: A paging frame is a radio frame in which the UE monitors the paging channel (PCH) as carried by the PDSCH for paging messages. The paging frame is specified in the System Information Block Type 2 (SIB2). A Paging Frame may contain one or more Paging Occasion(s).
Paging Occasion: A paging occasion is a specific subframe within a paging frame in which the network searches for an idle UE to which deliver data. The UE wakes up in a specific subframe within a radio frame. These specific subframes within a Paging Frame when UE wakes up are called Paging Occasions (POs). The paging occasion is determined by the combination of the paging cycle and the radio frame number (RFN) of the cell. A Paging Occasion is a subframe where there may be Paging-Radio Network Temporary Identifier (P-RNTI) transmitted on Physical Downlink Control Channel (PDCCH) addressing the paging message.
Paging Cycle: The paging Cycle defines the interval between consecutive paging occasions, and it may range from 16 to 2560 radio frames. Commonly used value for paging cycles is 128. It means 128 radio frames, and results in the that the UE may wake up after every 1.28 seconds even in Idle Mode to see if there is Paging information for the UE or not.
The Synchronization Signal/PBCH Block (SSB): The NR has two types of synchronization signals defined: Primary Synchronization Signal (PSS) and the Secondary Synchronization Signal (SSS). The Synchronization Signal/PBCH block (SSB) includes PSS, SSS and Physical Broadcast Channel (PBCH).
Primary Synchronization Signal (PSS): The PSS is a specific physical layer signal that is used for radio frame synchronization. When a UE is powered on and tuned to a specific frequency, the UE tries detecting a PSS. Once the UE is successful in detecting a PSS, the UE starts decoding the entire SSB. The PSS is generated by using a binary phase-shift keying (BPSK) modulated m-sequence of length 127. In LTE, Zadoff-Chu sequence is used for the generation of the PSS. The PSS helps the UE determine physical-layer identity NID⁽²⁾ and synchronization up to the periodicity of the PSS. It should be noted that in LTE, a cell ID is encoded in the PSS and SSS. The PSS has 3 values (0 to 2) and the SSS has 168 values (0 to 167). NID⁽¹⁾ is a shorthand for the value from the SSS and NID⁽²⁾ is a shorthand for the value from the PSS.
Secondary Synchronization Signal (SSS): The SSS is a specific physical layer signal that is used for radio frame synchronization. The SSS is generated by using BPSK modulated Gold sequence of length 127. Once the UE decodes the PSS, the UE knows one out of three identities for NID⁽²⁾ and after decoding the SSS, the PCI group number NID⁽¹⁾ is known to the UE. Using NID⁽¹⁾ and NID⁽²⁾, the PCI can be calculated as NIDCell=3* NID⁽¹⁾+NID⁽²⁾.
Physical Broadcast Channel (PBCH): The PBCH is a special channel to carry a master information block (MIB).
Control Resource Set #0 (CORESET #0): A CORESET is a set of time-frequency resources on the NR downlink resource grid where a PDCCH may be transmitted. The MIB provides a CORESET #0 configuration. A CORESET #0 configuration provides information related to the time and frequency resources used by the base station (e.g. the gNB) to transmit PDCCH.
PDCCH: The PDCCH carries downlink control information (DCI), which includes scheduling information required for downlink data, for example, Physical Downlink Shared Channel (PDSCH), reception by a UE.
DCI: The DCI is a set of information related to the schedule of the downlink data channel (e.g., PDSCH). A DCI may have its cyclic redundancy check (CRC) encoded by a specific RNTI (e.g., system information RNTI (SI-RNTI), P-RNTI, multicast control channel RNTI (MCCH-RNTI), paging early indication RNTI (PEI-RNTI)). The correct decoding of a DCI by a specific RNTI indicates to the UE that the DCI carries information for a specific type of downlink data channel (e.g., PDSCH). The DCI also carries information about the repetition of the PDSCH.
PDSCH: The PDSCH is a physical channel that carries user data (DL Payload).
Paging Message: Paging messages are provided by means of ordinary scheduled PDSCH transmissions. In order to allow for low device energy consumption, a device is only supposed to wake up at specific time instances, for example, once every 100 ms or even less often, to monitor for paging messages. The paging messages are indicated by a specific P-RNTI carried within the DCI. Once detecting such a DCI, the UE demodulates and decodes the corresponding PDSCH to extract the paging message(s). There may be multiple paging records carried by the paging message. Each record corresponds to a different device, within the same paging transmission. The P-RNTI is thus a shared identity.
Paging Record: A paging record specifies the UE which is being paged within the paging message. It specifies the UE identity and the core network domain. A maximum of 16 paging records may be included in the paging message.
5G Serving Temporary Mobile Subscriber Identity (5G-S-TMSI): The 5G-S-TMSI is a shortened version of the 5G globally unique temporary identifier (5G-GUTI), designed to facilitate efficiency in radio signaling procedures such as Paging and Service Request.

### Robust Paging

The Liaison Statement LS RP-234075 that the 3GPP Technical Specification Group (TSG) Service and System Aspects (SA) Work Group 1 (SA1) received from RAN discusses the need for new 3GPP service requirements which are proposed by the satellite industry in support of the UE to non-terrestrial networks (NTN) connectivity. The new service, known as Robust Notification Alert, is intended to increase the UEs' reachability via satellite access. RAN in the Liaison Statement LS RP-234075 noted that a robust notification/paging service should be addressed to a particular UE in a cell.

The intent of the service is to maximize the probability for a UE to be informed of a mobile terminated call when the UE is in very poor signal to noise ratio (SNR) conditions that prevent the UE from receiving a legacy (normal) paging message. This feature should be triggered by the network upon, for example, paging failure (e.g., when no paging response from the UE has been received by the network), or some other criteria. This feature may apply only for mobile terminated calls and may inform the user of a pending mobile terminated call to try to move to a location with better coverage so that a connection to the NTN may be established and the pending call may be completed. It is noted that this feature is highly desirable for satellite networks to reach users experiencing low SNR or Non-Line-of-Sight (NLOS) channel conditions.

### Potential Uses Cases of Robus Paging

The following requirements are the potential uses cases of robust paging: (1) a robust paging service may be enabled to operate on a UE, (2) the robust paging may operate when legacy paging has failed, (3) the legacy paging and the robust paging may operate concurrently on a UE, (4) legacy paging and the robust paging may operate orthogonally on a UE, (5) a UE may be configured by the network with robust paging operating parameters, (6) a UE configured with robust operating parameters may trigger the start of internal robust paging operations based on configured operating parameters and operating conditions, and (7) a UE configured with robust operating parameters may trigger the termination of internal robust paging operations based on configured operating parameters and operating conditions.

The current implementation of 3GPP does not support a robust paging service. In support of a robust paging service, the UE may need additional information regarding how to configure its robust paging service operations. There is a need to optimize how time and frequency resources are used to transport a robust paging message to a UE.

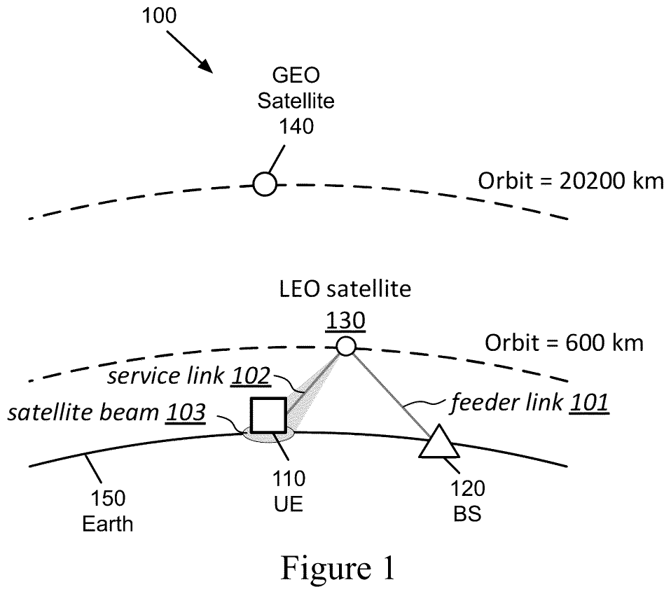

One example of a network that may use the robust paging service is an NTN, although other type of networks may also use the robust paging service. An NTN may refer to a network, or segments of a network, using spaceborne vehicles, such as Low Earth Orbit (LEO) or Geostationary Earth Orbit (GEO) satellites, for transmission. FIG. 1 is a diagram 100 illustrating an example of an NTN with an LEO satellite 130 implementing a transparent payload at orbit 600 km, according to an example implementation of the present disclosure. An NTN typically includes at least the following elements: (1) a gateway (GW) (not illustrated in FIG. 1); (2) a BS (e.g., the gNB 120); (3) a satellite 130; and (4) a UE 110. A ground or earth station may include a Satellite-gateway (Sat-gateway) and a Telemetry, Tracking, Command, and Monitoring (TTC & M) unit. One or several Sat-gateways may be attached to a BS baseband unit (BBU) or a BS (e.g., gNB) that connects the NTN to a core network or an application server. Node BBUs may be close to the Sat-gateways (e.g., either co-located or within a few kilometers), and the antenna diversity may be required depending on the geographical location and the feeder-link frequency band.

The satellite may be a GEO 140 or a non-GEO satellite. The satellite may be part of a satellite constellation to ensure the service continuity and may be served successively by one or several Sat-gateways. A satellite constellation controller may provide each BS with satellite system data (e.g., ephemeris, satellite position, velocity, etc.). The feeder link 101 may refer to a radio link conveying information for a satellite mobile service between a Sat-gateway and the satellite. A service link 102 may refer to a radio link between the UE and the satellite.

The satellite may implement a transparent payload. A transparent payload may include different operations, such as RF filtering, frequency conversion, amplification, etc., and the waveform signal repeated by the payload may be unchanged except for the frequency translation and the transmission power. A satellite typically generates several spot-beams (e.g., the satellite beam 103) over a given service area bounded by its Field of View (FoV) or footprint. The footprints of the spot-beams typically form an elliptic shape. The UE may be a Global Navigation Satellite System-capable (GNSS-capable) UE, such as a handheld device (e.g., an NR or LTE smartphone), an Internet of Things (IoT) device (e.g., a Narrowband IoT (NB-IoT) or enhanced machine-type communication device (eMTC device), a very-small-aperture terminal (VSAT), a moving platform (e.g., an aircraft, vessel, or building-mounted device), etc.

In an NTN, there may be several different scenarios, including the quasi-earth-fixed scenario, the earth-moving scenario, and the feeder-link-switch scenario. The quasi-earth-fixed scenario may refer to the case where a geographic area is served for one period and a different geographic area is served for another period. A platform, such as an LEO satellite, may create the quasi-earth-fixed beams if the satellite beam steering is supported. Handovers typically occur in bursts for all the UEs in each coverage area, e.g., every few minutes, in the quasi-earth-fixed scenario. The earth-moving scenario may refer to the case where a different geographic area is served from one instant to the next. The overall coverage area of the beams may be changing continuously.

A platform, such as an LEO satellite, may use the earth-moving beams and may cover different geographic areas, as the platform keeps orbiting the earth 150. When an NTN cell uses an earth-moving beam, every stationary UE may experience a change in the cell frequently, e.g., every few seconds. Handovers typically occur continuously in the earth-moving scenario. In the feeder-link-switch scenario, the timing information of a cell that is going to start or stop serving the area for the earth-fixed scenario may be broadcast to the UE via system information. The feeder-link-switch scenario may refer to the case where a link changes between the satellite and the GW, which may be co-located with a BS (e.g., a gNB). The duration of the feeder-link switch may be predictable based on the satellite ephemeris and the GW's location. The NW may broadcast the feeder-link switch period for the UE to stop or start the measurements, transmissions, or receptions.

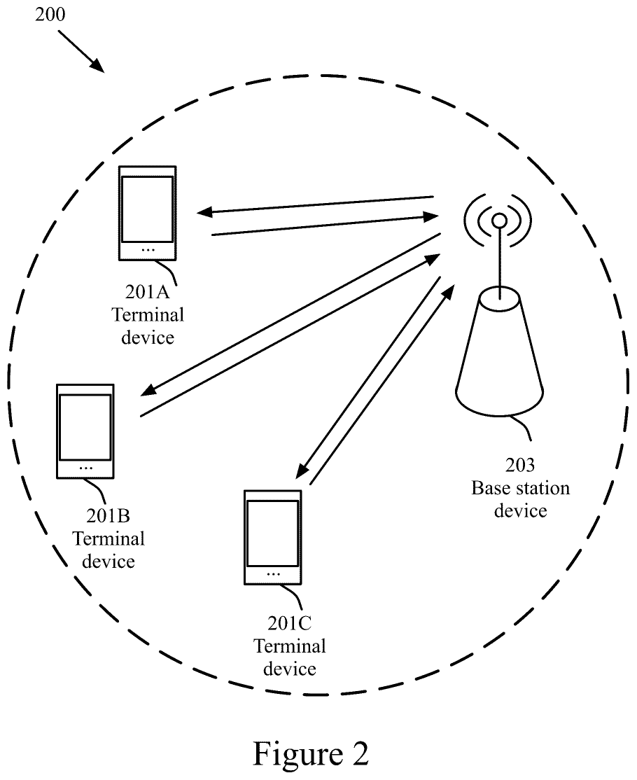

FIG. 2 is a schematic diagram illustrating another radio communication system, according to an example implementation of the present disclosure. In FIG. 2, the radio communication system 200 includes the terminal devices 201A to 201C and the base station device 203 (BS 203). The terms base station device, base station, and BS herein may be used interchangeably. The terms terminal device, user equipment, and UE herein may be used interchangeably.

The BS 203 may include one or more transmission/reception devices. When the BS 203 is configured of multiple transmission/reception devices, each of the multiple transmission/reception devices may be arranged at a different position. A transmission/reception device may include a transmission device and/or a reception device.

The BS 203 may serve radio communication and may provide one or more cells. A cell is defined as a set of resources used for a wireless communication. A cell may include one or both of a downlink component carrier and an uplink component carrier. A serving cell may include a downlink component carrier and two or more uplink component carriers.

The BS 120 (shown in FIG. 1), the BS 203 (shown in FIG. 2), or another network entity, such as a location management function (LMF) server, a RAN node, a CN node, a UE that is acting as a sidelink relay, etc., in some embodiments, may provide multiple sets of configurations to a UE, such as the UE 110 (shown in FIG. 1) or a UE 201A-201C (shown in FIG. 2) for a given functionality. The BS, or the other network node, may provide a mechanism to change the configuration sets based on changes in the UE environment or additional conditions.

In a wireless communication system, the configuration process, e.g., through the RRC signaling, is necessary for setting up, maintaining, and modifying the radio connection between the UE and the BS (e.g., a gNB) in the 5G/5G-Advanced (5G-A) networks. The BS or the network entity, may send a message, such as an RRC message, to a UE to configure at least one of the configuration parameters or features of a configuration set. This message may be, for example, RRCSetup, RRCReconfiguration, RRCResume, RRCRelease, or other downlink messages generated by the BS 203 or another network entity. The BS and/or the other network entities are considered as components of the network. In the following discussions, the term network, or network node, refers to any network entity, such as, BS (e.g., gNB), LMF server, a RAN node, a CN node, etc., and the BS may be used as an example of such network node.

The term “configuration,” herein, refers to the arrangement and specification of components, settings, or parameters within a system or device as defined by the applicable agreements, standards, or specifications. The term encompasses the established setup and customization of elements necessary to ensure compliance with contractual obligations, operational requirements, and performance criteria.

Configuring the UEs with Operating Parameters in Support of the Robust Paging Service

The network (e.g., the BS), in some embodiments, may configure the UEs with a set of operating parameters configured in a UE in support of the robust paging service (also referred to herein as robust paging). The set of operating parameters may be used by a UE capable of supporting the robust paging service for at least: (1) managing the interaction(s) between the robust paging service and the legacy paging service operations on the UE and (2) managing the robust paging service functions with respect to the reception of the robust paging time and frequency resources transmitted from a BS (e.g., a gNB) and legacy paging time and frequency resources transmitted from a BS.

Unless otherwise stated, the UE may be provisioned with one or more of the following operating parameters at time of manufacture, or via message, such as SIB messages, RRC messages, NAS messages, and MAC Control Element (MAC CE) messages. For example, the UE may be provisioned with IEs, such as RobustPage-Config-r20, SIBxx-r20, PDSCH-TimeDomainResourceAllocationList-r20, described below. This set of operating parameters may include at least the followings:
enableRobustPagingFunction: This parameter may be taken as a Boolean (True of False). This parameter, when set to True, may allow the UE capable of supporting the robust paging operations to execute the robust paging function. When False, the UE may not be allowed to execute the robust paging function.
contLegacyPagingWhileRobustPaging: This parameter may be taken as a Boolean (True of False). This parameter, when set to True, mat allow the UE capable of supporting the robust paging operations to concurrently execute the legacy paging functions (e.g., schedule, receive, process legacy paging messages) when the robust paging function is in operation. When False, the UE may not be allowed to execute legacy paging functions while the robust paging function is in operation.
robustPageRepetitionNumber: This parameter may be taken as an integer, with a range of 0 . . . n. This parameter may identify the number of PDSCH messages that will be transmitted during the robust paging occasion. This parameter may be transported as part of a new DCI format 1_0 message (e.g., a DCI format 1_0 that is not currently implemented by the 3GPP). This parameter may not be provisioned in the UE at time of manufacture, or via SIBx messages, RRC messages, NAS messages, or MAC CE messages. It should be noted that the PDSCH message may carry a robust paging message. The robust paging message may carry at most one robust paging record. The robust paging record may be addressed to a UE. It should be noted that SIBx denotes the SIB that the UE has requested the BS to transmit.
robustPageRepetitionNumber-r20: This parameter may be taken as an integer, with a range of 0 . . . n. This parameter may identify the number of PDSCH messages that may be transmitted during the robust paging occasion. It should be noted that the PDSCH message may carry a robust paging message. The robust paging message may carry at most one robust paging record. The robust paging record may be addressed to a UE.
robustMsgIdentity: This parameter may be taken as an array index. The index may be used to identify/access a string of text in an array of text strings. This parameter may be carried in the robust paging record. It is not at provisioned in the UE at time of manufacture, or via SIBx messages, RRC messages, NAS messages, or MAC CE messages.
robustMsgIdentities: This parameter may be taken as array of strings. Each string of the array may be associated with a robustMsgIdentity index. Each index may be associated with a caller identification (ID). The caller ID may be associated with a UE terminated call or a UE terminated text (also referred to as short message service (SMS)) message (i.e., the ID associated with the incoming service type) that triggered the robust paging service. The association between the caller ID and the UE terminated call or the UE terminated SMS may be configured in the robust paging service. The strings of the parameter may represent text that may be displayed on the UE display upon successful reception of a robust paging message that includes a robustMsgIdentity.
maxFailedLegacyPagingOccasions: This parameter may be taken as an integer, with a range of 0 . . . n. This parameter may identify the maximum number of consecutive (or sequential) legacy paging occasions that a UE may fail to receive. When the number of sequential legacy paging occasions that a UE has failed to receive equals this parameter, the UE's robust paging function may be triggered to start.
maxFailedRobustPagingOccasions: This parameter may be taken as an integer, with a range of 0 . . . n. This parameter may identify the maximum number of sequential robust paging occasions that a UE may fail to receive. When the number of sequential robust paging occasions that a UE has failed to receive equals this parameter, the UE's robust paging function may terminate. It should be noted that one value in the range of 0 . . . n may be reserved to indicate that the number of maxFailedRobustPagingOccasions is infinite. This value may nominally 0 or n.

With reference to the above parameter, the following parameters may be configured to the UE at time of manufacture, or via messages, such as SIBs messages, RRC messages, NAS message, or MAC CE messages:
enableRobustPagingFunction
contLegacyPagingWhileRobustPaging
robustPageRepetitionNumber-r20
robustMsgIdentities
maxFailedLegacyPagingOccasions
maxFailedRobustPagingOccasions

The following parameters may be obtained by UE in support of robust paging service:
robustPageRepetitionNumber
robustMsgIdentity
robust-5G-S-TMSI

### Procedure for Transporting a Robust Paging Message Using Optimized Time and Frequency Resources

A robust paging service has to operate at very low received signal levels. To enhance the probability that a UE may correctly decode a single robust paging message, the same message may be transmitted multiple times over a given period. Additionally, paging messages may include several parts, and one or more correctly decoded parts (e.g., as confirmed by their CRC) of a first repeated message may be aggregated with the correctly decoded other parts of the repeated messages to create a fully decoded message. For example, if a first part of an individual message is decoded but the second part is not, and the first part of a different individual message is not decoded correctly but the second part is decoded, then the first part of the first message may be combined with the second part of the second message to create a fully decoded message. This operation is referred to as message aggregation.

Additionally, the size of a message may directly impact the probability of the message being successfully decoded. For example, if a message is 1 bit and the message is repeated n times, then the probability of correctly decoding that message is:

$$P ( at least one successful decode ) = 1 - P ( failure to successfully decode ) * n$$

In contrast, the probability of decoding a message that is n bits that is transmitted only once is:

$$P ( at least one successful decode ) = 1 - P ( failure to successfully decode )$$

Therefore, it may be desirable to minimize the message size to be able to transmit it multiple times.

To provide for a paging procedure (e.g., a robust paging procedure) that may receive a paging message at lower received signal strengths than a legacy paging procedure, a new transport mechanism is described in the following. The general idea is to reduce the number of bits required to send the robust paging message and at the same time increase the probability of receiving the robust paging message by increasing the number of times that the robust page message is repeated.

A network capable of supporting the robust paging service may transit a MIB as part of its robust paging procedure that provides an indication (e.g., a single bit referred to herein as robustPagingActive) that the robust paging service is active or inactive. When the robust paging service is indicated as active via the MIB, the time and frequency resources associated with that MIB may be carrying a PDCCH. The PDCCH may be carrying a new DCI format 1_0 message that is encoded with a robust paging RNTI. The PDSCH indicated by the new DCI format 1_0 message that is encoded with a robust paging RNTI may be carrying a robust paging message. The robust paging message may be carrying a robust paging record. It should be noted that the enableRobustPagingFunction parameter, described above, allows the UE to attempt the reception of a robust page (when the required conditions are met). However, there is no guarantee that, when the UE has started attempting the reception of a robust page, the BS is actually transmitting a robust page. Therefore, at the very first opportunity to provide the UE with some kind of information (e.g., the MIB), the BS may provide the robustPagingActive as an early indication to the UE whether or not there is a robust page being transmitted. If there is no robust paging being transmitted, then the UE does not need to waste any more power attempting to receive a message that is not there.

A UE capable of supporting the robust paging service may be configured to use a new RNTI value. The new RNTI value, referred to herein as robust paging RNTI (RobustPage-RNTI) may be used to decode the new DCI format 1_0 message. The RobustPage-RNTI may be configured into the UE at time of manufacture.

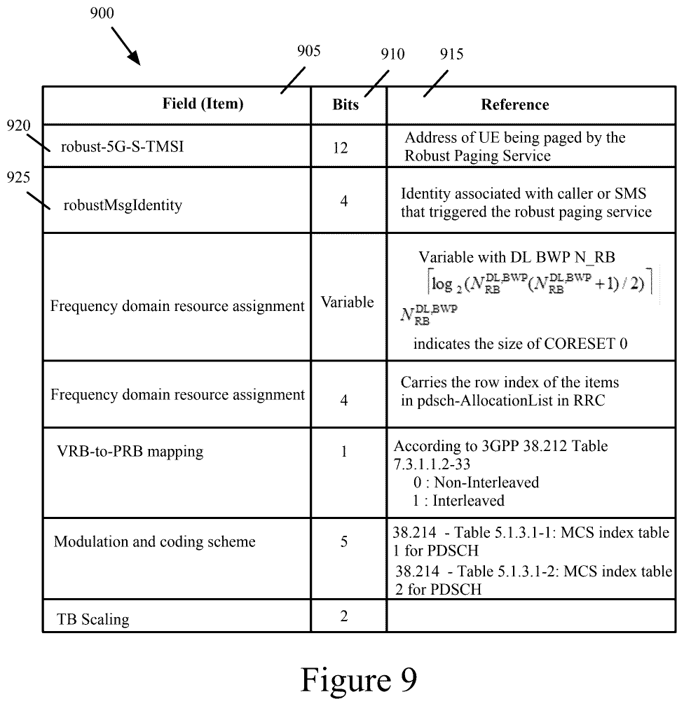

The new DCI format 1_0 message may include a cyclic redundancy check (CRC). The CRC of the new DCI format 1_0 message may be decoded by the RobustPage-RNTI. For example, the CRC of the new DCI format 1_0 message may be scrambled by the RobustPage-RNTI value before transmission by the BS. After the new DCI format 1_0 message is received by the UE, the message may be de-scrambled via the same RobustPage-RNTI value. For example, a 16 bit CRC of a DCI message may be added bitwise mod2 to the 16-bit robust paging RNTI to decode it. If the CRC calculated for the DCI message equals the CRC decoded by the robust paging RNTI, then the DCI message is the new DCI format 1_0 message of type robust paging. The format of this DCI Format 1_0 message is shown in FIG. 9, described below.

A UE capable of supporting the Robust Paging service may be configured to recognize the content of the new DCI format 1_0 message that is encoded by the RobustPage-RNTI. The new DCI format 1_0 message may contain one or more of the following information elements (IEs) described above: enableRobustPagingFunction, contLegacyPagingWhileRobustPaging, robustPageRepetitionNumber, robustPageRepetitionNumber-r20, robustMsgIdentity, robustMsgIdentities, maxFailedLegacyPagingOccasions, and maxFailedRobustPagingOccasions.

A network capable of supporting the robust paging service may configure the UE via at time of manufacture, or via SIBx messages, RRC messages, NAS messages, or MAC CE messages with a PDSCH-TimeDomainResourceAllocation-r20 IE. The IE may carry the IE robustPageRepetitionNumber-r20, described above. This parameter identifies the number of PDSCH messages that may be transmitted during the robust paging occasion that is associated with the DCI format 1_0 message that is encoded by the RobustPage-RNTI. The UE may use the IE robustPageRepetitionNumber-r20 as part of its robust paging function.

However, if the UE subsequently receives a DCI format 1_0 message scrambled by RobustPage-RNTI that carries the IE robustPageRepetitionNumber, then the UE may use the value of IE robustPageRepetitionNumber instead of the value of the robustPageRepetitionNumber-r20 for the duration that the time and frequency resources associated with the DCI format 1_0 message are transmitted.

The robust paging message IE may carry only one robust paging record. The robust paging message may be transported via PDSCH such that the PDSCH is suitable for aggregated decoding for the duration that the time and frequency resources associated with the new DCI format 1_0 message is transmitted. The UE may be configured to use a new robust paging record IE that is carried by a Robust Paging Message. The robust paging record may carry the address of the UE that the robust paging service is trying to page. The address of the robust paging record may be in the form of a robust-5G-S-TMSI. The robust paging record may carry only one robust-5G-S-TMSI.

The robust paging record may carry the robustMsgIdentity described above. The robustMsgIdentity is an identification number (e.g., an index) that is used to identify one of n text strings in the robustMsgIdentities array of text strings. The robustMsgIdentity may be used to associate an incoming call or SMS message that triggered the robust paging service to page the UE with one of the n possible strings in the robustMsgIdentities array.

The UE may be configured with a first 5G-S-TMSI at time of manufacture. If the UE decodes the robust paging record that carries a second 5G-S-TMSI, referred to herein as robust-5G-S-TMSI, from the robust paging record that is the same as the first 5G-S-TMSI configured in the UE (assuming the same number of bits are compared), then that UE is being paged by the robust paging service. The UE may then be considered as having received a robust page targeted to the UE from the robust paging service. If the robust paging record also carries a robustMsgIdentity, the UE may use the value of robustMsgIdentity as the index into the preconfigured array robustMsgIdentities. The string of text in robustMsgIdentities as indexed by robustMsgIdentity may be used to provide the user with some information about the incoming call or SMS that triggered the robust paging service.

In some embodiments, the 5G-S-TMSI and the robust-5G-S-TMSI may each be of size of n bits. In these embodiments, if the values represented by the n-bits is equivalent, then the UE may determine that it is being paged by the network's robust paging service.

In some embodiments, the robust-5G-S-TMSI may be of size n-bits and the 5G-S-TMSI may be of size m-bits and n is smaller than m. In these embodiments, if the value represented by the n bits of the robust-5G-S-TMSI is equivalent to the value of the first n of m bits of the 5G-S-TMSI, then the UE may determine that it is the being paged by the network's robust paging service. In these embodiments, the number of bits addressing the UE as carried in the robust paging record may be less than the number of bits assigned to the UE as the 5G-S-TMSI address. In this way, the network may dynamically control how many bits are used (e.g., how many bits are needed) to address a UE via the robust paging service.

If the 5G-S-TMSI assigned to the UE is equivalent to the robust-5G-S-TMSI, and if the robust paging record carries a robustMsgIdentity, the value of robustMsgIdentity may be used as an index into the array robustMsgIdentities to obtain a sting with some information about the caller ID that triggered the robust paging service. The network may configure UE, for example, via an RRC message with PDSCH-TimeDomainResourceAllocation-r20 IE. The IE may carry the IE robustPageRepetitionNumber-r20 disclosed in the present embodiments.

### Alternative Procedure for Transporting a Robust Paging Message Using Optimized Time and Frequency Resources

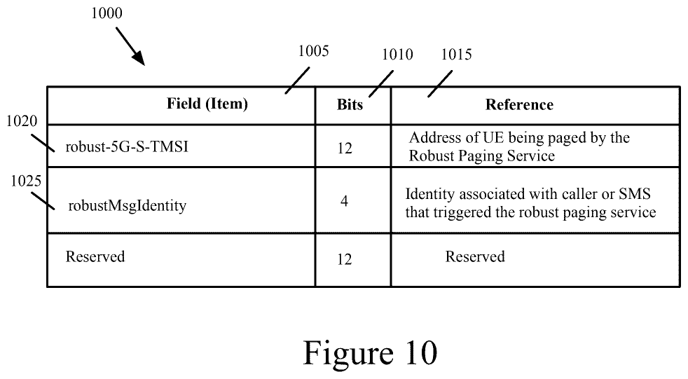

Some embodiments provide for a minimal number of transmitted data to inform a specific UE of a robust page, and an optionally robust page cause identity. In these embodiment, the above-mentioned DCI Format 1_0 message may be reduced in size to carry only the robust-5G-S-TMSI. In some of these embodiments, the DCI Format 1_0 message may carry the only the robust-5G-S-TMSI and the robustMsgIdentity. The format of this DCI Format 1_0 message is shown in FIG. 10, described below.

A robust paging service must operate at very low received signal levels. To enhance the probability that a UE may correctly decode a robust paging message it is desirable to minimize message size and the number of protocol steps required to deliver the message. To provide for a paging procedure (i.e. a robust paging procedure) that may receive a paging message at lower received signal strength than a legacy paging procedure, a new transport mechanism is described in the following. The general idea is to minimize the number of bits of the robust paging message and the number of protocol steps required to deliver the message.

A network capable of supporting the robust paging service may transit a MIB as part of its robust paging procedure that provides an indication (e.g., a single bit) that the robust paging service is active or inactive. When the robust paging service is indicated as active via the MIB, the time and frequency resources associated with that MIB may be carrying a PDCCH. The PDCCH may be carrying a new DCI format 1_0 message that is encoded with a robust paging RNTI. The new DCI format 1_0 message that is encoded with a robust paging RNTI may be carrying robust paging information.

A UE capable of supporting the robust paging service may be configured to use robust paging RNTI (RobustPage-RNTI) value to decode the DCI format 1_0 message. The RobustPage-RNTI may be configured into the UE at time of manufacture. The CRC of the DCI format 1_0 message may be decoded by the RobustPage-RNTI. The CRC of the DCI format 1_0 message may be scrambled by the RobustPage-RNTI value before transmission by the BS, and after the DCI format 1_0 message is received by the UE, it may be de-scrambled via the same RobustPage-RNTI value. For example, the 16 bit CRC of a DCI message may be added bitwise mod2 to the 16-bit robust paging RNTI to decode it. If the CRC calculated for the DCI message equals the CRC decoded by the robust paging RNTI, then the DCI message is the DCI format 1_0 message of type robust paging.

The UE may be configured to recognize the content of a new DCI format 1_0 message that is encoded by the RobustPage-RNTI. The new DCI format 1_0 message that is decoded by the RobustPage-RNTI may contain at least the following IE for a UE: (1) the robust-5G-S-TMSI, which identifies the UE to which the robust paging system is sending the page via the robust-5G-S-TMSI. and (2) the robustMsgIdentity, which may identify a string that is associated with the ID of the UE terminated call, or the UE terminated SMS (e.g., the incoming service type) that triggered the robust paging service.

The UE may be configured with a 5G-S-TMSI. The 5G-S-TMSI may be configured in the UE at time of manufacture. If the UE decodes the DCI format 1_0 that carries a robust-5G-S-TMSI that is the same as the 5G-S-TMSI configured in the UE (assuming the same number of bits are compared), then the UE is being paged by the robust paging service. The UE may then be considered as having received a robust page targeted from the robust paging service.

In some embodiments, the robust-5G-S-TMSI may be of size n-bits and the 5G-S-TMSI may be of size m-bits and n may be smaller than m. In these embodiments, if the value represented by the n bits of the robust-5G-S-TMSI is equivalent to the value of the first n of m bits of the 5G-S-TMSI, then the UE may determine that it is the being paged by the network's robust paging service. In these embodiments, the number of bits addressing the UE as carried in the robust paging record may be less than the number of bits assigned to the UE as the 5G-S-TMSI address. In this way, the network may dynamically control how many bits are used (e.g., how many bits are needed) to address a UE via the robust paging service.

Additionally, if the decoded DCI format 1_0 also carries a robustMsgIdentity, then a string of text in robustMsgIdentities as indexed by robustMsgIdentity may be used to provide the user with some information about the incoming call or SMS that triggered the robust paging service.

### Pseudo Code for the UE Side Operation of the Robust Paging Service

The utilization of the provisioned set of operating parameters of the present embodiments is described in the following pseudo code for the UE side operation of the Robust Paging Service.

// The Initialize_RPS_Function obtains the operating parameters used by the UE's robust paging
// service from the UE's memory and configures the run-time parameters used by the UE's robust
// paging Service. The parameters stored in the UE's memory were provisioned into the UE from either
// (1) a data set provisioned on the UE at time of manufacture, (2) a data set as received by the UE via
// a SIBx message, (3) a data set as received by the UE via an RRC messaging, or (4) a data set as
// received by the UE via an NAS messaging.
Initialize_RPO_Function( )
// The Initialize_RPO_Function obtains, from the UE's memory, the set of operating parameters
// used by the robust paging service. The set includes at least:

| | |
|---|---|
| enableRobustPagingFunction | = UE_Memory(enableRobustPagingFunction) |
| contlegacyPagingWhileRobustPaging | = |

UE_Memory(contLegacyPagingWhileRobustPaging)

| | |
|---|---|
| robustPageRepetitionNumber-r20 | = UE_Memory(robustPageRepetitionNumber-r20) |
| robustMsgIdentities | = UE_Memory(robustMsgIdentities) |
| maxFailedLegacyPagingOccasions | = UE_Memory(maxFailedLegacyPagingOccasions) |
| maxFailedRobustPagingOccasions | = UE_Memory(maxFailedRobustPagingOccasions) |

```
// The Initialize_RPO_Function configures the Robust Paging Service run-time parameters.
// The set includes at least:
    failedLegacyPagingOccastions = 0
    failedRobustPagingOccastions = 0
// The Initialize_RPO_Function begins the robust paging service operations via the function call....
    Target_Next (Legacy Paging Occasion)
// The function Target_Next( ) instructs the UE's scheduler to schedule for the UE's next legacy paging
// occasion and (or) the UE's next robust paging occasion. The function takes as an input parameter
// the type of paging occasion that should be scheduled.
  Target_Next (Param)
      If (Param == Legacy_Paging_Occasion)
// The function Target_Next_Legacy_Paging_Occastion( ) is used to schedule the UE to wake up to
// attempt a reception of an SSB at the start of the UE's next legacy paging cycle (as may be defined
// by the default paging occasion (PO), the paging frame (PF), and the discontinuous reception (DRX)
// cycle assigned to this UE)for receiving legacy paging messages. An example of how this function
// may progress is that at the of the next legacy paging cycle for this UE, the UE targets the proper
// SSB that carries the PBCH, start which carries the MIB. The presence of the MIB indicates that
// PDCCH resources may be found in the Common Search Space (a table of time/frequency resources
// that define the Common Search Space is previously configured in the UE via RRC signaling). The
// PDCCH carries the DCI format 1_0 message which is encoded by the P_RNTI. The encoded DCI
// format 1_0 message carries the row index into the table pdsch-AllocationList-r17 (which may be
// configured previously via RRC signaling). The entries indexed in table pdsch-AllocationList-r17
// carries the PDSCH-TimeDomainResourceAllocation-r17.
// The PDSCH-TimeDomainResourceAllocation-r17 identifies the time/frequency resources that carry
// the PDSCH. The PDSCH carries a legacy paging message. The legacy paging message may carry
// up to 32 paging records. One of the paging records may be addressed to this UE.
  Target_Next_Legacy_Paging_Occastion( )
      If (Param == Robust_Paging_Occasion)
//The function Target_Next_Robust_Paging_Occastion( ) is used to schedule the UE to wake up to
// attempt a reception of an SSB at the next Robust Paging Cycle (as may be defined by robust paging
// occasion (RPO), PF, and robust DRX cycle assigned to this UE) for receiving robust paging
// messages. An example of how this function may progress is that at the start of the next robust paging
// cycle for this UE, the UE targets the proper SSB that carries the PBCH, which carries the MIB. The
// presence of the MIB indicates that PDCCH resources may be found in the Common Search Space.
// The PDCCH carries the new DCI format 1_0 message with is encoded by the
// RobustPage_RNTI. The encoded new DCI format 1_0 message carries the row index into the table
// pdsch-AllocationList-r20 (which is configured previously via RRC signaling). The entries indexed
// in table pdsch-AllocationList-r20 carries the PDSCH-TimeDomainResourceAllocation-r20. The
// PDSCH-TimeDomainResourceAllocation-r20 identifies the time/frequency resources that carry the
// PDSCH. The PDSCH carries a Robust Paging Message. The robust paging message may carry 1
// robust paging record. The robust paging record may be addressed to this UE. The Robust Paging
// Message may carry 1 robust paging identity. The robust paging identity is used as an index into the
// array of robust paging identities.
    Target_Next_Robust_Paging_Occastion( )
// The function Process_Results_Last_Legacy_Paging_Occasion( ) obtains the results of the last
// attempt by the UE to receive a legacy paging message, as triggered by the scheduled reception of a
// legacy SSB at the UE's legacy paging occasion. The results are then parsed by this function to
// determine if a legacy paging message was received at the last paging occasion. If a legacy paging
// message is not received, the function may set UE_Decoded_Legacy_Paging_Channel = FALSE.
// Otherwise, it will set UE_Decoded_Legacy_Paging_Channel = TRUE
    Process_Results_Last_Legacy_Paging_Occasion( )
// The function Get_Results_Last_SSB( ) returns the results of the reception attempt of the last
// targeted SSB, and any other time/frequency resources that may be pointed at by the components of
// the last targeted SSB. The results of the last SSB reception attempt, and the results of attempting to
// receive any other time/frequency resources that may be pointed at by the components of valid SSB
// reception attempt may be an indication that the components of the SSB or that the sub-components
// of the SSB may or may not be correctly decoded or the contents of the sub-components are or are
// not germane to the process of receiving a paging message for this UE
  Result = Get_Result_Last_SSB( )
  If (Result == PSS_NOT_DECODED)
        UE_Decoded_Legacy_Paging_Channel = FALSE
  Else If (Result == SSS_NOT_DECODED)
        UE_Decoded_Legacy_Paging_Channel = FALSE
  Else If (Result == PBCH_NOT_DECODED)
        UE_Decoded_Legacy_Paging_Channel = FALSE
// Decoded SSB contains 3 data objects [PSS, PBCH, SSS], so next consider if content of PBCH
// contained a MIB.
  Else If (Result == SSB.PBCH_DOES_NOT_CONTAIN_MIB)
        UE_Decoded_Legacy_Paging_Channel = TRUE
// The above means if no MIB, there is no paging data transmitted
// SSB.PBCH contained a MIB, so next consider if Type-2 PDCCH resources can be found in common
// space, as indicated by the MIB that was decoded
  Else If (Result == SSB.PBCH.MIB.PDCCH_NOT_DECODED)
        UE_Decoded_Legacy_Paging_Channel = FALSE
// The above means a type 2 PDCCH in common search space could not be decoded
// SSB.PBCH.MIB.PDCCH was decoded. So, next consider if there was an active paging channel by
// de-scrambling via P-RNTI
  Else If (Result != (PDCCH.DCI_1_0_CRC_Scrambled_By_P-RNTI))
        UE_Decoded_Legacy_Paging_Channel = TRUE
// The above means there is no paging on the paging channel
// SSB.PBCH.MIB.PDCCH.DCI had an active paging channel. So, next consider if there was only a
reserved field indicator
  Else If (Result != (PDCCH.DCI_1_0_CRC_Scrambled_By_P-
RNTI_ShortMessageIndicator_00)
        UE_Decoded_Legacy_Paging_Channel = TRUE
// The above means no pages, only reserved Subscriber Microservices Infrastructure (SMI)
// SSB.PBCH.MIB.PDCCH.DCI has an active paging channel. So, next consider if there only Short
// Messages such as a “systemInfoModification” indication message or a “etwsAndCmasIndication”
// indication message.
  Else If (Result != (PDCCH.DCI_1_0_CRC_Scrambled_By_P-RNTI_ShortMessageIndicator_10)
        UE_Decoded_Legacy_Paging_Channel = TRUE
// The above means no pages, only Short Message
// The function has now determined that the paging channel is active with active paging messages.
// But, it has not determined if there is a page addressed to this UE (e.g., as carried in the PDSCH
// pointed at by DCI format 1_0 message of the PDCCH)
  Else
// The field “Time domain resource assignment” in DCI format 1_0 message decoded by P-RNTI
// carries the row index of the items in pdsch-AllocationList-r17 (which is configured previously via
//either RRC PDSCH-Config and PDSCH-ConfigCommon). The rows of pdsch-AllocationList17
// carry the IE PDSCH-TimeDomainResourceAllocation-r17, which carries the IE repetitionNumber-
//r17. The repetitionNumber-r17 indicate the number of PDSCH that are repeatedly scheduled as
// associated to the DCI format 1_0 message. The paging message carried by the PDSCH contains at
// max 32 paging records, each assigned to a different UE.
        MAX_PDSCH_ATTEMPTS = repetitionNumber-r17
        For (i == 1, i < MAX_PDSCH_ATTEMPTS, i++)
// The Receive_Next_PDSCH( ) function attempts to receive the targeted PDSCH, and returns the
// results of that PDSCH reception attempt. The results may be an indication that the PDSCH could or
// could not be correctly decoded.
              Result = Receive_Next_PDSCH( )
              If (Result == PDSCH_DECODED)
                    UE_Decoded_Legacy_Paging_Channel = TRUE
// The above means paging channel is decoded
                    Break
// The above forces an exit to the for loop, as the loop is done
// If the control gets to end of the for loop and have reached max PDSCH attempts, then no PDSCH
was decoded in this PO
        If ( i == MAX_PDSCH_ATTEMPTS)
              UE_Decoded_Legacy_Paging_Channel = FALSE
// The function Process_Results_Last_Robust_Paging_Occasion( ) obtains the results of the last
// attempt by the UE to receive a robust paging message, as triggered by the scheduled reception of a
// SSB at the UE's robust paging occasion. The results are then parsed by this function to determine if
// a robust paging message was received at the last robust paging occasion. If a robust paging message
// is not received, the function may set UE_Decoded_Robust_Paging_Channel = FALSE. Otherwise,
  // the function may set UE_Decoded_Robust_Paging_Channel = TRUE. The function may also
//attempt to aggregate PDSCH messages that failed to be decoded during this paging occasion. If the
// result of the aggregation process is a valid PDSCH message the function may set
// UE_Decoded_Robust_Paging_Channel = TRUE
Process_Results_Last_Robust_Paging_Occasion( )
// The function Get_{——}Results_Last_SSB( ) returns the results of the reception attempt of the last
// targeted SSB, and any other time/frequency resources that may be pointed at by the components of
// the last targeted SSB. The results of the last SSB reception attempt, and the results of attempting to
// receive any other time/frequency resources that may be pointed at by the components of valid SSB
// reception attempt may be an indication that the components of the SSB or that the sub-components
// of the SSB may or may not be correctly decoded or contents of the sub-components are or are not
germane to the process of receiving a paging message for this UE.
Result = Get_Result_Last_SSB( )
        If (Result == PSS_NOT_DECODED)
            UE_Decoded_Robust_Paging_Channel = FALSE
        Else If (Result == SSS_NOT_DECODED)
            UE_Decoded_Robust_Paging_Channel = FALSE
        Else If (Result == PBCH_NOT_DECODED)
            UE_Decoded_Robust_Paging_Channel = FALSE
// Decoded SSB contains 3 data objects (PSS, PBCH, SSS), so next consider if content of PBCH
// contains a MIB.
        Else If (Result == SSB.PBCH_DOES_NOT_CONTAIN_MIB)
            UE_Decoded_Robust_Paging_Channel = TRUE
// The above means if there is no MIB, there is no page
// SSB.PBCH contained a MIB, so next consider there is a bit indication that Robust Paging is being
// transmitted
        Else If (Result != SSB.PBCH.MIB. robustPagingActive)
            UE_Decoded_Legacy_Paging_Channel = FALSE
// The above means robust pages are not being transmitted
// SSB.PBCH.MIB indicates that the robust paging is currently being transmitted. So, next consider
// if Type-2 PDCCH resources may be found in common space, as indicated by the MIB, was decoded
      Else If (Result == SSB.PBCH.MIB.PDCCH_NOT_DECODED)
          UE_Decoded_Robust_Paging_Channel = FALSE
// The above means a type 2 PDCCH could not decoded in common search space
// SSB.PBCH.MIB.PDCCH was decoded. So next consider if there was an active paging channel by
// de-scrambling the DCI carried by the PDCCH via RobustPage-RNTI
      Else If (Result != (PDCCH.DCI_1_0_CRC_Scrambled_By_RobustPage-RNTI)
          UE_Decoded_Robust_Paging_Channel = TRUE
// The above means there is no paging on paging channel
// The function has now determined that the robust paging channel is active with active robust paging
// messages via the MIB that carries the robustPagingActive bit. But the UE has not decoded the
// paging message that carries the address of the paged UE (e.g., as may be carried in the
// PDSCH.RobustPagingMessage.RobustPagingRecord that is pointed at by the DCI format 1_0
// message of the PDCCH that was decoded by RobustPage-RNTI)
      Else
// The field “Time domain resource assignment” in the DCI format 1_0 message decoded by the
// RobustPage-RNTI carries the row index of the items in pdsch-AllocationList-r20 (which is
previously configured via, for example, either RRC PDSCH-Config and PDSCH-ConfigCommon).
// The rows of pdsch-AllocationList-r20 carry the IE PDSCH-TimeDomainResourceAllocation-r20,
// which carries the IE robustPageRepetitionNumber-r20. The robustPageRepetitionNumber-r20
// indicates the number of PDSCH that are associated to a new DCI format 1_0 message decoded by
// RobustPage-RNTI that carry a robust paging message. The robust paging message carried by the
// PDSCH contains only 1 paging record, that of the UE that the robust paging service is targeting (a
// legacy paging message may carry up to 32 paging records, each assigned to a different UE). By
// carrying only 1 paging record, the time/frequency resources used by of the PDSCH are minimized,
// and each identical (minimized) PDSCH may be aggregated. Thus, with the increased number of
// repetitions of the PDSCH, the probability of decoding the PDSCH may be improved. (e.g., If parts
// of the received PDSCH is determined to be erroneous then the receiver buffers the correct parts of
// the received PDSCH and target the next repeat re-transmission of the same PDSCH by the sender.
// When the receiver receives the repeated PDSCH, it may then combine the additional new correct
// parts of the received PDSCH with buffered data in an attempt to create a fully correct PDSCH from
// the parts of the PDSCH that were previously correctly received)
// If the new DCI format 1_0 message decoded by the RobustPage-RNTI carries a
// robustPageRepetitionNumber IE, that value should be used instead of the value of
// the robustPageRepetitionNumber-r20 as was configured. for example, by RRC signaling for
// receiving the time and frequency resources associated with the new DCI format 1_0 message.
              If (PDCCH.DCI_1_0_CRC_Scrambled_By_RobustPage-RNTI.
                robustPageRepetitionNumber != NULL)
                MAX_ROBUST_PAGE_PDSCH_ATTEMPTS =
                PDCCH.DCI_1_0_CRC_Scrambled_By_RobustPage-RNTI.
RobustPageRepetitionNumber
              else
                MAX_ROBUST_PAGE_PDSCH_ATTEMPTS =
robustPageRepetitionNumber-r20
              For (i == 1, i < MAX_ROBUST_PAGE_PDSCH_ATTEMPTS, i++)
// The Receive_Next_PDSCH( ) function attempts to receive the targeted PDSCH, and returns the
// results of that PDSCH reception attempt. The result may be an indication that the PDSCH may
// or may not be correctly decoded.
                  Result = Receive_Next_PDSCH( )
                  If (Result == PDSCH_DECODED)
                      UE_Decoded_Robust_Paging_Channel = TRUE
// The above means the paging channel decoded
                  Break
// The above means force an exit to the for loop, as the loop is complete
// The Aggregate_Last_PUSCH ( ) function attempts to aggregate partially decoded PDSCH messages
// in an attempt to produce a single decodable message. The robust paging service uses the same
// single robust paging message in each PDSCH scheduled by the new DCI format 1_0 message
// decoded by RP_RNTI. Thus, all repetitions of the PDSCH contain the same data, thus partially
// decoded PDSCH messages may be candidates for aggregation.
                If (Result == PDSCH_PARTIALLY_DECODED)
                      Result = Aggregate_Last_PUSCH( )
                      If (Result == PDSCH_DECODED)
                        UE_Decoded_Robust_Paging_Channel = TRUE
// The above means paging decoded
                        Break
// The above means force an exit to the for loop, as the loop is
// If the control gets to end of the for loop and have reached max PDSCH attempts, then no PDSCH
// was decoded in this RPO
              If ( i == MAX_ROBUST_PAGE_PDSCH_ATTEMPTS)
                UE_Decoded_Robust_Paging_Channel = FALSE
```

### Alternative for the Process_Results_Last_Robust_Paging_Occasion( )

```
// The function Process_Results_Last_Robust_Paging_Occasion( ) obtains the results of the last
// attempt by the UE to receive a robust paging message, as triggered by the scheduled reception of a
SSB at the UE's robust paging occasion. The results are then parsed by this function to determine if a
// robust paging message was received at the last robust paging occasion. If a robust paging message
// is not received, the function may set UE_Decoded_Robust_Paging_Channel = FALSE. Otherwise,
// the function may set UE_Decoded_Robust_Paging_Channel = TRUE. The function may also
// attempt to aggregate PDSCH messages that failed to be decoded during this paging occasion. If the
// result of the aggregation process is a valid PDSCH message the function may set
// UE_Decoded_Robust_Paging_Channel = TRUE
Process_Results_Last_Robust_Paging_Occasion( )
// The function Get_{——}Results_Last_SSB( ) returns the results of the reception attempt of the last
// targeted SSB, and any other time/frequency resources that may be pointed at by the components of
// the last targeted SSB. The results of the last SSB reception attempt, and the results of attempting to
// receive any other time/frequency resources that may be pointed at by the components of valid SSB
// reception attempt may be an indication that the components of the SSB or that the sub-components
// of the SSB may or may not be correctly decoded or contents of the sub-components are or are not
// germane to the process of receiving a paging message for this UE.
    Result = Get_Result_Last_SSB( )
    If (Result == PSS_NOT_DECODED)
      UE_Decoded_Robust_Paging_Channel = FALSE
    Else If (Result == SSS_NOT_DECODED)
      UE_Decoded_Robust_Paging_Channel = FALSE
    Else If (Result == PBCH_NOT_DECODED)
      UE_Decoded_Robust_Paging_Channel = FALSE
// Decoded SSB contains 3 data objects (PSS, PBCH, SSS). So, next consider if the content of the
// PBCH contains a MIB.
    Else If (Result == SSB.PBCH_DOES_NOT_CONTAIN_MIB)
      UE_Decoded_Robust_Paging_Channel = TRUE
// The above means if there is no MIB, there is no page
// SSB.PBCH contained a MIB. So, next consider if there is a bit indication that robust paging is
// being transmitted
    Else If (Result != SSB.PBCH.MIB. robustPagingActive)
      UE_Decoded_Legacy_Paging_Channel = FALSE
// The above means the robust pages are not being transmitted.
// SSB.PBCH.MIB indicates that Robust Paging is currently being transmitted. So, next consider if
// Type-2 PDCCH resources that may be found in common space, as indicated by the MIB, was
// decoded
    Else If (Result == SSB.PBCH.MIB.PDCCH_NOT_DECODED)
      UE_Decoded_Robust_Paging_Channel = FALSE
// The above means a type 2 PDCCH could not decode in common search space
// SSB.PBCH.MIB.PDCCH was decoded. So next consider if there was an active paging channel by
de-scrambling the DCI carried by the PDCCH via RobustPage-RNTI
  Else If (Result != (PDCCH.DCI_1_0_CRC_Scrambled_By_RobustPage-RNTI)
    UE_Decoded_Robust_Paging_Channel = TRUE
// The above means there is no paging on paging channel
// The function has now determined that the robust paging channel is active with active robust paging
// messages via the MIB that carries the robustPagingActive bit. But, the UE has not determined if
// there is a page addressed to a UE. (e.g., as may be carried in the
//PDCCH.DCI_1_0_CRC_Scrambled_By_RobustPage-RNTI)
  Else
// If the new DCI format 1_0 message decoded by the RobustPage-RNTI carries a
// robust-5G-S-TMSI IE, that value should be used instead of the value of
// robustPageRepetitionNumber-r20 as was configured, for example, by RRC signaling for receiving
// the time and frequency resources associated with the new DCI format 1_0 message. Otherwise,
// use the value configured by RRC signaling.
    If (PDCCH.DCI_1_0_CRC_Scrambled_By_RobustPage-RNTI. robust-5G-S-TMSI !
= NULL)
        UE_Decoded_Robust_Paging_Channel = TRUE
// The above means paging channel decoded
    else
        UE_Decoded_Robust_Paging_Channel = FALSE
// Following each legacy paging occasion reception attempt, the
// Process_Legacy_Paging_Occasion_Reception_Attempt( ) function is called to determine if the
// content of the legacy paging channel was decoded or not. If so, continue with the legacy paging
// occasion. Otherwise, if the robust paging function is enabled, then increment the failed legacy
// counter and check if the counter has reached a threshold. If the threshold is reached, then target the
// next robust paging occasion
Process_Legacy_Paging_Occasion_Reception_Attempt( )
  If (enableRobustPagingFunction == FALSE)
    failedLegacyPagingOccastions = 0
    Target_Next (Legacy_Paging_Occasion)
  Else
    If (UE_Decoded_Legacy_Paging_Channel == TRUE)
          failedLegacyPagingOccastions = 0
          Target_Next (Legacy_Paging_Occasion)
    Else // UE may not decode the content of the legacy paging channel
          failedLegacyPagingOccastions += 1
          If (failedLegacyPagingOccastions == maxFailedLegacyPagingOccasions)
                failedRobustPagingOccastions = 0
                Target_Next (Robust_Paging_Occasion)
                If (contLegacyPagingWhileRobustPaging == TRUE)
                  Target_Next (Legacy_Paging_Occasion)
                Else // The legacy paging is on hold until robust paging terminates
// reset legacy paging counter in prep for re-starting legacy paging
                  failedLegacyPagingOccastions = 0
                Else // Continue legacy paging until max failures occur
                  Target_Next (Legacy_Paging_Occasion)
// Following each robust paging occasion reception attempt, the
// Process_Robust_Paging_Occasion_Reception_Attempt( ) function is called to determine if the
// content of the robust paging channel was decoded or not. If so, return to legacy paging occasion.
// Otherwise, if max robust paging occasion attempts have been made return to legacy paging
//occasion. Otherwise, continue with robust paging occasion
Process_Robust_Paging_Occasion_Reception_Attempt( )
  If (UE_Decoded_Robust_Paging_Channel == TRUE)
    If robust-5G-S-TMSI == 5G-S-TMSI
        Robust Page is addressed to this UE
        If robustMsgIdentity != NULL
            Info about source of robust page = robustMsgIdentities[robustMsgIdentity]
            failedLegacyPagingOccastions = 0
            failedRobustPagingOccastions = 0
            Target_Next (Legacy_Paging_Occasion),
  Else // UE is not able to decode the content of the robust paging channel)
    If (maxFailedRobustPagingOccasions != 0) //0 defines infinite RPO attempts
        failedRobustPagingOccastions += 1
        If (failedRobustPagingOccastions >= maxFailedRobustPagingOccasions)
            failedLegacyPagingOccastions = 0
            Target_Next (Legacy_Paging_Occasion)
        Else
            Target_Next (Robust_Paging_Occasion)
        Else // Configured for infinite RPO
// Sanity check that infinite RPO cannot be enabled unless NPO is also enabled
            If (contLegacyPagingWhileRobustPaging == FALSE)
              failedLegacyPagingOccastions = 0
              failedRobustPagingOccastions = 0
              Target_Next (Legacy_Paging_Occasion)
            Else
              Target_Next (Robust_Paging_Occasion)
```

### Example State Diagram for UE Robust Paging Service

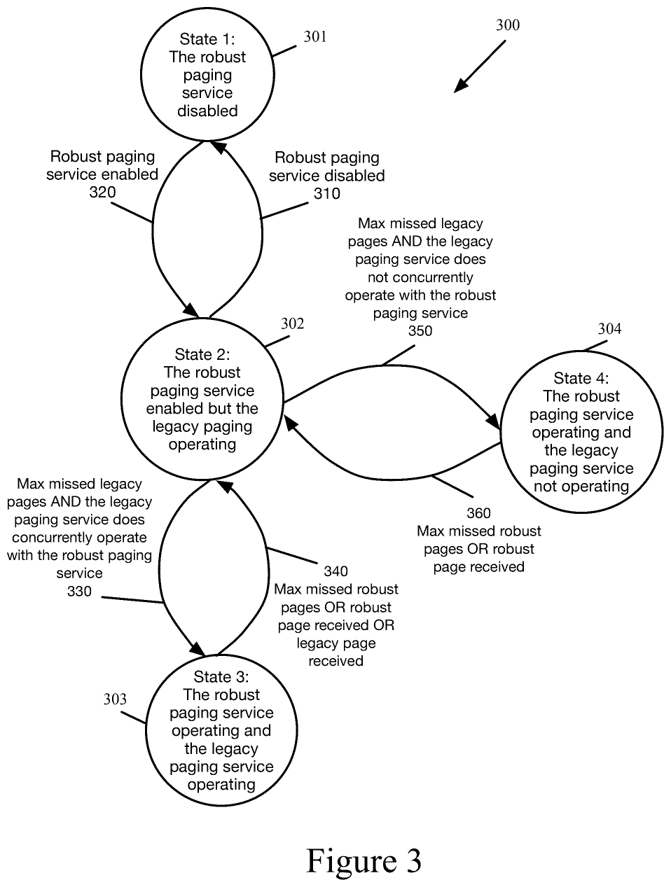

FIG. 3 is a state diagram 300 illustrating the states of a UE's robust paging service, according to an example implementation of the present disclosure. The state diagram includes four operating states 301-304 and the events 310-360 that may trigger a transition between the states.

As shown, in the first state 301, the robust paging service may be disabled. The UE may enter the first state 301 when the UE receives an indication (as shown by the arrow 310) that the robust paging service is disable. For example, the UE may receive the enableRobustPagingFunction parameter with its value set to False.

In the second state 302, the robust paging service may be enabled but the legacy paging service may be operating. The UE may enter the second state 302 from the first state 301 after receiving an indication (as shown by the arrow 320) that the robust paging service is enabled. For example, the UE may receive the enableRobustPagingFunction parameter with its value set to True. It should be noted that in the second state 302, the robust paging service is enabled but the legacy paging is operating.

The UE from transition from the second state 302 to the third state 303 (as shown by the arrow 330) when the maximum number of missed legacy pages is reached and the legacy paging service does concurrently operate with the robust paging service. For example, the number of missed legacy pages may reach the maxFailedLegacyPagingOccasion parameter and the contLegacyPagingWhileRobustPaging parameter may be set to True.

In the third state 303, the robust paging service and the legacy paging service may be concurrently operating. The UE may transition from the third state 303 to the second state 302 (as shown by the arrow 340) after either (1) the maximum number of missed robust pages is reached (e.g., the number of missed robust pages reaches the maxFailedRobustPagingOccasions parameter), (2) a robust page is received, or (3) a legacy page is received.

The UE from transition from the second state 302 to the fourth state 304 (as shown by the arrow 350) when the maximum number of missed legacy pages is reached and the legacy paging service does not concurrently operate with the robust paging service. For example, the number of missed legacy pages may reach the maxFailedLegacyPagingOccasion parameter and the contLegacyPagingWhileRobustPaging parameter may be set to False.

In the fourth state 304, the robust paging service may be concurrently operating, and the legacy paging service may not be operating. The UE may transition from the fourth state 304 to the second state 302 (as shown by the arrow 360) after either (1) the maximum number of missed robust pages is reached (e.g., the number of missed robust pages reaches the maxFailedRobustPagingOccasions parameter) or (2) a robust page is received.

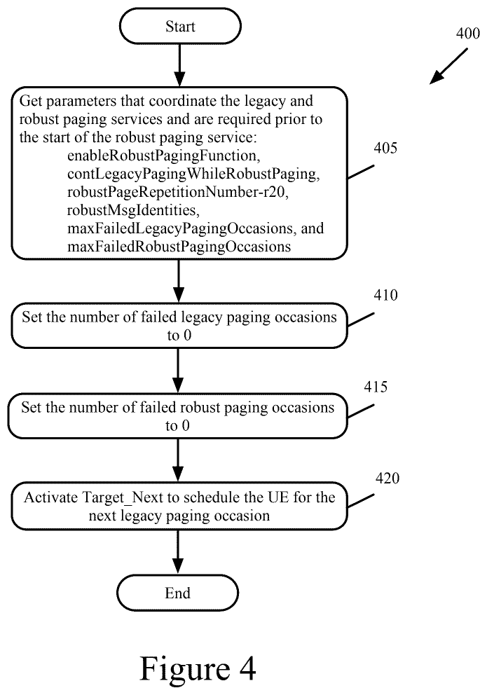

FIG. 4 is a flowchart illustrating an example method/process 400 performed by a UE for initializing the robust paging service procedure, according to an example implementation of the present disclosure. The process 400, in some embodiments, may be performed by at least one processor of a UE such as the UE 120 shown in FIG. 1 or the UEs 201A-201C shown in FIG. 2.

The process 400 may get (at block 405) the parameters that coordinate the legacy and robust paging services and are required prior to the start of the robust paging service. For example, the parameters may include the followings: (1) a parameter, such as the enableRobustPagingFunction that allows a UE which is capable of supporting robust paging service to execute the robust paging function, (2) a parameter, such as the contLegacyPagingWhileRobustPaging parameter that allows a UE which is capable of supporting robust paging service to concurrently execute legacy paging functions when the robust paging function is in operation, (3) a parameter, such as the robustPageRepetitionNumber-r20 parameter which identifies the number of PDSCH messages that may be transmitted during the robust paging occasion, (4) a parameter, such as the robustMsgIdentities parameter that may be an array of strings, one of which may be displayed on the UE display after successful reception of a robust paging message that includes an index to the array of strings, (5) a parameter, such as the maxFailedLegacyPagingOccasions parameter that identifies the maximum number of consecutive legacy paging occasions that UE may fail to receive before the UE's robust paging function may be triggered to start, and (6) a parameter, such as the maxFailedRobustPagingOccasions parameter that identifies the maximum number of consecutive robust paging occasions that the UE may fail to receive before the UE's robust paging function is terminated. It should be noted the UE uses several other parameters, such as the robustPageRepetitionNumber and the robustMsgIdentity that the UE may receive after the robust paging function is executed.

The process 400 may set (at block 410) the number of failed legacy paging occasions to 0. For example, the process 400 may set the variable Failed_Legacy_Paging_Occasions variable to 0. The process 400 may set (at block 415) the number of failed robust paging occasions. For example, the process 400 may set the variable Failed_Robust_Paging_Occasions to 0.

The process 400 may then activate (at block 420) the Target_Next (Legacy Paging Occasion) function that was described in the pseudo codes above. The function Target_Next( ) instructs the UE's scheduler to schedule for the UE's next legacy paging occasion and/or the UE's next robust paging occasion. The Target_Next function takes as an input parameter the type of paging occasion that should be scheduled. In block 420, the Target_Next is activated with a constant, such as, the “Legacy Paging Occasion” constant to indicate that the UE's scheduler has to schedule for the UE's next legacy paging occasion. The process 400 may then end.

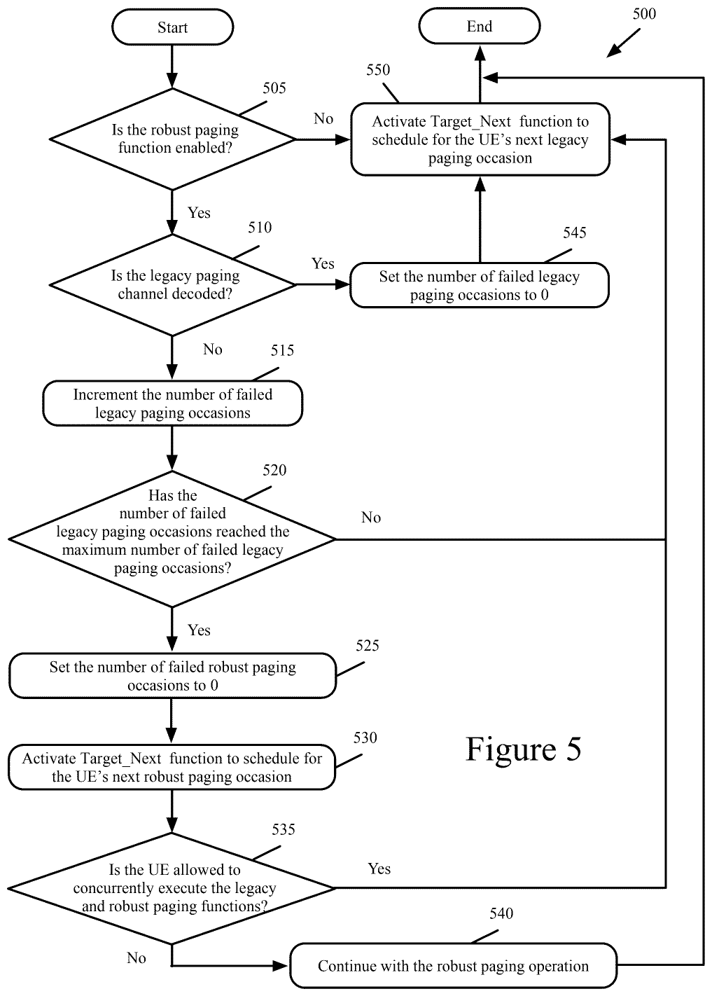

FIG. 5 is a flowchart illustrating an example method/process 500 performed by a UE for tracking the legacy paging operations that may trigger the start of the robust paging operation, according to an example implementation of the present disclosure. The process 500, in some embodiments, may be performed by at least one processor of a UE such as the UE 120 shown in FIG. 1 or the UEs 201A-201C shown in FIG. 2.

The process 500 may decide (at block 505) whether the robust paging function is enabled. For example, the process 500 may determine whether the enableRobustPagingFunction parameter described above is set to True. If the robust paging function is not enabled, the process 500 may activate (at block 550) the Target_Next function to schedule for the UE's legacy paging occasion. For example, the process 500 may activate the Target_Next function with the constant “Legacy Paging Occasion” to indicate that the UE's scheduler has to schedule for the UE's next legacy paging occasion. The process 500 may then end.

If the robust paging function is enabled, the process 500 may decide (at block 510) whether the legacy paging channel is decoded. If the legacy paging channel is decoded, the process 500 may set (at block 545) the number of failed legacy paging occasions to 0. For example, the process 500 may set the parameter Failed_Legacy_Paging_Occasions, described above, to 0. The process 500 may then proceed to block 550, which was described above.

If the legacy paging channel is not decoded, the process 500 may increment (at block 515) the number of failed legacy paging occasions. For example, the process 500 may increment the variable Failed_Legacy_Paging_Occasions described above.

The process 500 may then decide (at block 520) whether the number of failed legacy paging occasions has reached the maximum number of consecutive legacy paging occasions that UE may fail to receive before the UE's robust paging function may be triggered to start. For example, the process 500 may determine the variable Failed_Legacy_Paging_Occasions has reached the value of the maxFailedLegacyPagingOccasions parameter.

If the number of failed legacy paging occasions has reached the maximum number of consecutive legacy paging occasions, the process 500 may proceed to block 550, which was described above. Otherwise, the process 500 may set (at block 525) the number of failed robust paging occasions to 0. For example, the process 500 may set the variable Failed_Robust_Paging_Occasions, described above, to 0.

The process 500 may then activate (at block 530) the Target_Next function to schedule for the UE's robust paging occasion. For example, the process 500 may activate the Target_Next function with the constant “Robust Paging Occasion” to indicate that the UE's scheduler has to schedule for the UE's next robust paging occasion.

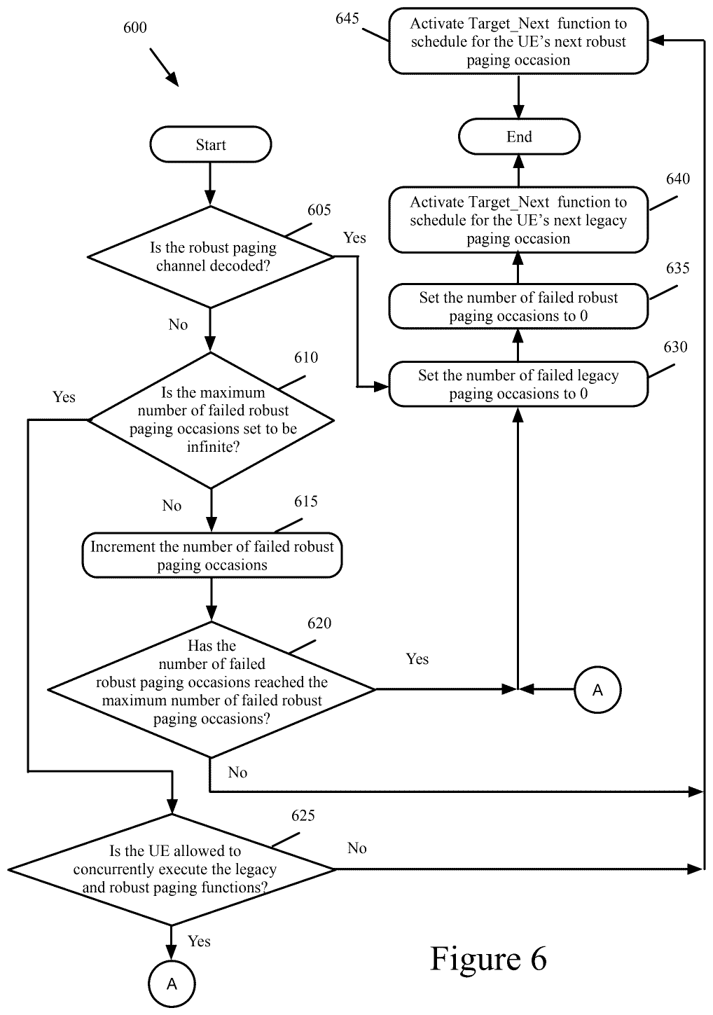

The process 500 may then decide (at block 535) whether the UE is allowed to concurrently execute the legacy and robust paging functions. For example, the process 500 may decide whether the contLegacyPagingWhileRobustPaging, described above, is set to True. If the UE is allowed to concurrently execute the legacy and robust paging functions, the process 500 may proceed to block 550, which was described above. Otherwise, the process 500 may continue (at block 540) with the robust paging operation, as described below with reference to FIG. 6. The process 500 may then end.

FIG. 6 is a flowchart illustrating an example method/process 600 performed by a UE for tracking the robust paging operations that may trigger the end of the robust paging operation, according to an example implementation of the present disclosure. The process 600, in some embodiments, may be performed by at least one processor of a UE such as the UE 120 shown in FIG. 1 or the UEs 201A-201C shown in FIG. 2.

The process 600 may determine (at block 605) as to whether the robust paging channel is decoded. For example, the process 600 may determine whether the UE_Decoded_Robust_Paging_Channel, described in the pseudo code above, is set to True. If the robust paging channel is not decoded, the process 600 may proceed to block 610, which is described below. If the robust paging channel is decoded, the process 600 may set (at block 630) the number of failed legacy paging occasion to 0. For example, the process 600 may set the parameter Failed_Legacy_Paging_Occasions, described above, to 0.

The process 600 may set (at block 635) the number of failed robust paging occasions to 0. For example, the process 600 may set the variable Failed_Robust_Paging_Occasions, described above, to 0. The process 600 may then activate (at block 640) the Target_Next function to schedule for the UE's next legacy paging occasion. For example, the process 600 may activate the Target_Next function with the constant “Legacy Paging Occasion” to indicate that the UE's scheduler has to schedule for the UE's next legacy paging occasion. The process 600 may then end.

If the process 600 determines (at block 605) that the robust paging channel is not decoded, the process 600 may decide (at block 610) whether the maximum number of failed robust paging occasions is set to be infinite. For example, in some embodiments, the maxFailedRobustPagingOccasion, described above, may be set to 0 to indicate the maximum number of failed robust paging occasions is infinite. If the maximum number of failed robust paging occasions is set to be infinite, the process 600 may proceed to block 625, which is described below.

Otherwise, the process 600 may increment (at block 615) the number of failed robust paging occasions. For example, the process 600 may increment the variable Failed_Robust_Paging_Occasions described above. The process 600 may then decide (at block 620) whether the number of failed robust paging occasions has reached the maximum number of failed robust paging occasion that UE may fail to receive before the UE's robust paging function may be stopped. For example, the process 600 may determine the variable Failed_Robust_Paging_Occasions has reached the value of the maxFailedRobustPagingOccasions parameter.

If the number of failed robust paging occasions has reached the maximum number of failed robust paging occasion, the process 600 may proceed to block 630, which was described above. Otherwise, if the number of failed robust paging occasions has not reached the maximum number of failed robust paging occasion the process 600 may activate (at block 645) the Target_Next function to schedule for the UE's next robust paging occasion. For example, the process 600 may activate the Target_Next function with the constant “Robust Paging Occasion” to indicate that the UE's scheduler has to schedule for the UE's next robust paging occasion. The process 600 may then end.

If the process 600 determines (at block 610) that the maximum number of failed robust paging occasions is set to be infinite, the process 600 may determine (at block 625) whether the UE is allowed to concurrently execute the legacy and robust paging functions. For example, the process 600 may decide whether the contLegacyPagingWhileRobustPaging, described above, is set to True.

If the UE is allowed to concurrently execute the legacy and robust paging functions, the process 600 may proceed to block 630, which was described above. Otherwise, the UE is not allowed to concurrently execute the legacy and robust paging functions, the process 600 may proceed to block 645, which was described above.

Example of a MIB That Carries the Robust_Paging_Active indication

Some embodiments may provide a MIB that may include the system information transmitted on PBCH. For example, some embodiments may provide the following MIB:

-- ASN1START
MIB ::= SEQUENCE {

| | |
|---|---|
| systemFrameNumber | BIT STRING (SIZE (6)), |
| subCarrierSpacingCommon | ENUMERATED {scs15or60, |
| | scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| robustPagingActive | ENUMERATED {TRUE, FALSE}, |

}
--ASN1STOP

### Example of a RobustPage-RNTI

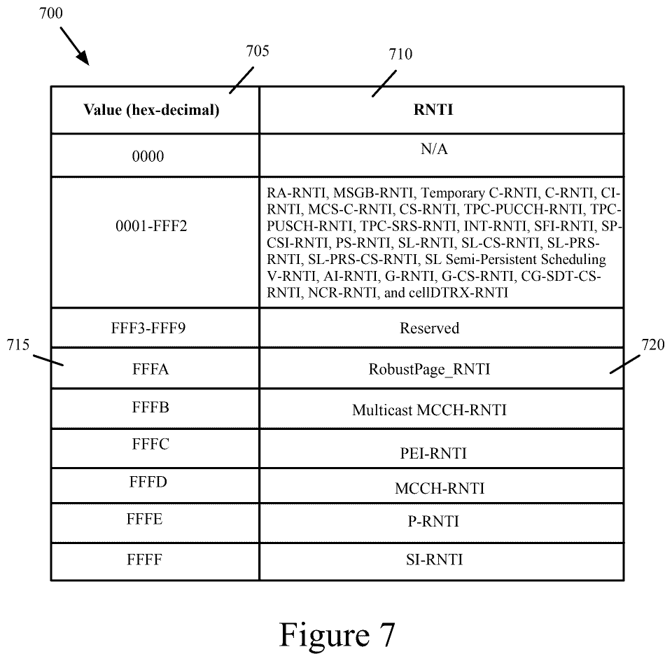

FIG. 7 illustrates a table 700 that includes an example of a RobustPage_RNTI that may be defined in the RNTI table of 3GPP specification 38.321, according to an example implementation of the present disclosure. As shown in FIG. 700, the table 700 shows the value 705 of different RNTIs 720. In the example of FIG. 7, the hexadecimal value of FFFA (as shown by 715) is assigned to the robust paging RNTI 720, referred to herein as RobustPage_RNTI. It should be noted that any of the other currently reserved values FFF3-FFF9 may be assigned to the robust paging RNTI instead of the hexadecimal value of FFFA.

### Examples of DCI Format 1_0 With CRC Scrambled by RobustPage-RNTI

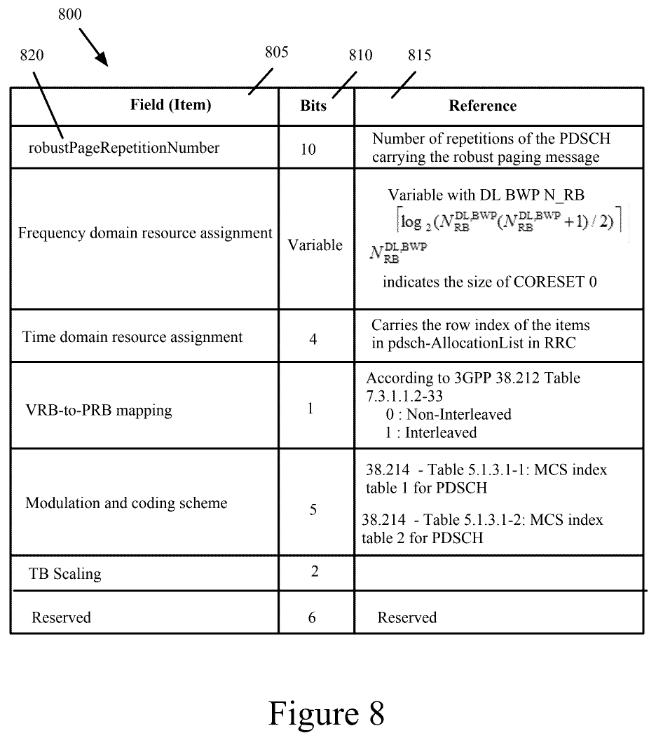

FIG. 8 illustrates a table 800 that includes an example of DCI format 1_0 with CRC scrambled by RobustPage-RNTI that may be defined in 3GPP specification 38.212, according to an example implementation of the present disclosure. As shown in FIG. 800, the table 800 lists the field items 805 and provides the number of bits 810 and the reference 815 for each field item 805. In the example of FIG. 8, the field item robustPageRepetitionNumber 820 may be used to identify the number of repeated PDSCH messages that are scheduled to transport robust paging messages.

FIG. 9 illustrates a table 900 that includes another example of DCI format 1_0 with CRC scrambled by RobustPage-RNTI that may be defined in 3GPP specification 38.212, according to an example implementation of the present disclosure. As shown in FIG. 900, the table 900 lists the field items 905 and provides the number of bits 910 and the reference 915 for each field item 905.

With reference to FIG. 9, the robust-5G-S-TMSI field item 920 may indicate the address of the UE that is being paged by the robust paging service. The robustMsgIdentity 925 may indicate the identity associated with caller or SMS that triggered the robust paging service.

FIG. 10 illustrates a table 1000 that includes another example of DCI format 1_0 with CRC scrambled by RobustPage-RNTI that may be defined in 3GPP specification 38.212, according to an example implementation of the present disclosure. As shown in FIG. 1000, the table 1000 lists the field items 1005 and provides the number of bits 1010 and the reference 1015 for each field item 905.

With reference to FIG. 10, the DCI format 1_0 may only include the robust-5G-S-TMSI field 1020 and optionally the robustMsgIdentity 1025. The rest of the field items 1005 may be reserved.

### Example of an IE for 5G-S-TMSI in the 3GPP Specification 38.331

The following is an example of an IE for the 5G-S-TMSI in the 3GPP Specification 38.331. The IE 5G-S-TMSI may include the 5G-S-TMSI, which is a temporary UE identity provided by the 5GC which uniquely identifies the UE within the tracking area.

-- ASN1START
5G-S-TMSI ::= BIT STRING (SIZE (48))
-- ASN1STOP

### Example of an IE RobustPagingMessage

Some embodiments provide an IE referred to as, RobustPagingMessage, for a robust paging message. The Robust Paging message is used for the notification of only 1 UE. The signaling radio bearer is N/A, the RLC-SAP is TM, the logical channel is PCCH, the direction is the network to the UE.

The following is an example of a robust paging message defined via ASN.1 format that may be included in 3GPP specification 38.331.

-- ASN1START

| RobustPagingMessage ::= | SEQUENCE { | |
|---|---|---|
| robustPagingRecordList | RobustpagingRecordList | OPTIONAL, -- Need N |
| lateNonCriticalExtension | OCTET STRING | OPTIONAL, |

}
RobustPagingRecordList ::= SEQUENCE (SIZE(1)) OF RobustPagingRecord
RobustPagingRecord ::= SEQUENCE {

| | | |
|---|---|---|
| robust-5G-S-TMSI | BIT STRING (SIZE (n)) | OPTIONAL, -- Need S |
| robustMsgIdentity | BIT STRING (SIZE (n)) | OPTIONAL, -- Need S |

}
-- ASN1STOP

### Example of IE PDSCH-TimeDomainResourceAllocationList in 3GPP Specification 38.331

The IE PDSCH-TimeDomainResourceAllocation may be used to configure a time domain relation between PDCCH and PDSCH. The PDSCH-TimeDomainResourceAllocationList may contain one or more of such PDSCH-TimeDomainResourceAllocations. The network may indicate in the DL assignment which of the configured time domain allocations the UE shall apply for that DL assignment. The UE may determine the bit width of the DCI field based on the number of entries in the PDSCH-TimeDomainResourceAllocationList. Value 0 in the DCI field refers to the first element in this list, value 1 in the DCI field refers to the second element in this list, and so on.

The following is an example of the IE PDSCH-TimeDomainResourceAllocationList that may be included in 3GPP specification 38.331:

-- ASN1START
PDSCH-TimeDomainResourceAllocationList ::= SEQUENC (SIZE(1..maxNrofDL-Allocations))
OF PDSCH-TimeDomainResourceAllocation
PDSCH-TimeDomainResourceAllocation ::= SEQUENCE {

| | |
|---|---|
| k0 | INTEGER(0..32) OPTIONAL, -- Need S |
| mappingType | ENUMERATED {typeA, typeB}, |
| startSymbolAndLength | INTEGER (0..127) |

}
PDSCH-TimeDomainResourceAllocationList-r16 ::= SEQUENCE (SIZE(1..maxNrofDL-
Allocations)) OF PDSCH-TimeDomainResourceAllocation-r16
PDSCH-TimeDomainResourceAllocation-r16 ::= SEQUENCE {

| | |
|---|---|
| k0-r16 | INTEGER(0..32) OPTIONAL, -- Need S |
| mappingType-r16 | ENUMERATED {typeA, typeB}, |
| startSymbolAndLength-r16 | INTEGER (0..127), |
| repetitionNumber-r16 | ENUMERATED {n2, n3, n4, n5, n6, n7, n8, n16} OPTIONAL, |
| | -- Cond Formats1-0and1-1 |

```
  ...
}
PDSCH-TimeDomainResourceAllocationList-r17 ::= SEQUENCE (SIZE(1.. maxNrofDL-
Allocations)) OF MultiPDSCH-TimeDomainResourceAllocation-r17
  MultiPDSCH-TimeDomainResourceAllocation-r17 ::= SEQUENCE {
```

| | |
|---|---|
| pdsch-AllocationList-r17 | SEQUENCE (SIZE(1..maxNrofMultiplePDSCHs-r17)) OF |
| | PDSCH-TimeDomainResourceAllocation-r17, |

```
  ...
}
PDSCH-TimeDomainResourceAllocation-r17 ::= SEQUENCE {
  k0-r17 INTEGER (0..128) OPTIONAL, -- Need S
```

| | |
|---|---|
| mappingType-r17 | ENUMERATED {typeA, typeB}, |
| startSymbolAndLength-r17 | INTEGER (0..127), |

repetitionNumber-r17 ENUMERATED {n2, n3, n4, n5, n6, n7, n8, n16} OPTIONAL,

-- Cond Formats1-0and1-1

```
  ...
}
PDSCH-TimeDomainResourceAllocationList-r20 ::= SEQUENCE (SIZE(1.. maxNrofDL-
Allocations)) OF MultiPDSCH-TimeDomainResourceAllocation-r20
  MultiPDSCH-TimeDomainResourceAllocation-r20 ::= SEQUENCE {
```

| | |
|---|---|
| pdsch-AllocationList-r20 | SEQUENCE (SIZE(1..maxNrofMultiplePDSCHs-r20)) OF |
| | PDSCH-TimeDomainResourceAllocation-r20, |

```
  ...
}
PDSCH-TimeDomainResourceAllocation-r20 ::= SEQUENCE {
  k0-r20 INTEGER (0..128) OPTIONAL, -- Need S
```

| | |
|---|---|
| mappingType-r20 | ENUMERATED {typeA, typeB}, |
| startSymbolAndLength-r20 | INTEGER (0..127), |

repetitionNumber-r20 ENUMERATED {n2, n3, n4, n5, n6, n7, n8, n16} OPTIONAL,

-- Cond Formats1-0and1-1

robustPageRepetitionNumber-r20 INTEGER (0..n) OPTIONAL,

-- Cond Formats1-0and1-1

...
}
-- ASN1STOP

With reference to the above IE, the entries PDSCH-TimeDomainResourceAllocationList-r20, PDSCH-TimeDomainResourceAllocation-r20, and robustPageRepetitionNumber-r20 are not currently included in 3GPP.

### Example of a SIB That Carries the Information Required for Robust Paging

The following is an example of a SIB that Carries the Information Required for Robust Paging according to some embodiments:

-- ASN1START
-- TAG- SIBxx-START
SIBxx-r20 ::= SEQUENCE {

| | |
|---|---|
| robustPage-Config-r20 | RobustPage-Config-r20, |
| lateNonCriticalExtension | OCTET STRING OPTIONAL, |

}
RobustPage-Config-r20 ::= SEQUENCE {

| | |
|---|---|
| enableRobustPagingFunction | BOOLEAN |
| contLegacyPagingWhileRobustPaging | BOOLEAN |
| maxFailedLegacyPagingOccasions | INTEGER (0..n) |
| maxFailedRobustPagingOccasions: | INTEGER (0..n) |

robustMsgIdentities SEQUENCE(SIZE(1..maxNoMultipleRobustMsgIDs)) of

robustMsgIdentity

}
robustMsgIdentity BIT STRING (SIZE (n)) OPTIONAL, -- Need S
-- TAG- SIBxx-START
-- ASN1STOP

### Example of an RRC ConfigCommon That Carries the Information Required for Robust Paging

The following is an example of an RRC ConfigCommon that Carries the Information Required for Robust Paging. The IE PDSCH-ConfigCommon may be used to configure cell specific PDSCH parameters.

-- ASN1START
-- TAG-PDSCH-CONFIGCOMMON-START
PDSCH-ConfigCommon ::= SEQUENCE {
pdsch-TimeDomainAllocationList PDSCH-TimeDomainResourceAllocationList OPTIONAL,

| | |
|---|---|
| | -- Need R |
| robustPage-Config-r20 | RobustPage-Config-r20, |
| ... | |
| } | |

RobustPage-Config-r20 ::= SEQUENCE {

| | |
|---|---|
| enableRobustPagingFunction | BOOLEAN |
| contLegacyPagingWhileRobustPaging | BOOLEAN |
| maxFailedLegacyPagingOccasions | INTEGER (0..n) |
| maxFailedRobustPagingOccasions: | INTEGER (0..n) |

robustMsgIdentities SEQUENCE(SIZE(1..maxNoMultipleRobustMsgIDs)) of

| | |
|---|---|
| | robustMsgIdentity |
| } | |
| robustMsgIdentity | BIT STRING (SIZE (n)) OPTIONAL, -- Need S |

-- TAG-PDSCH-CONFIGCOMMON-STOP
-- ASN1STOP

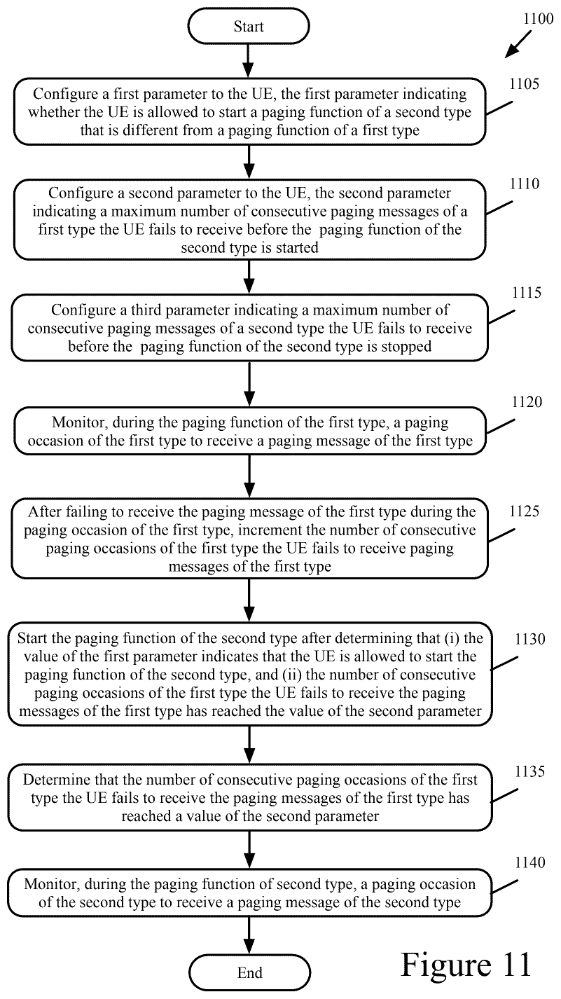

FIG. 11 is a flowchart illustrating an example method/process 1100 performed by a UE for configuring the UE with different types of paging functions, according to an example implementation of the present disclosure. The process 1100, in some embodiments, may be performed by at least one processor of a UE such as the UE 120 shown in FIG. 1 or the UEs 201A-201C shown in FIG. 2.

The process 1100 may configure (at block 1105) a first parameter to the UE, the first parameter indicating whether the UE is allowed to start a paging function of a second type that is different from a paging function of a first type. For example, the process 1100 may configure the enableRobustPagingFunction parameter, described above, to the UE. The first type may be legacy paging and the second type may be robust paging.

The process 1100 may configure (at block 1110) a second parameter to the UE, the second parameter indicating a maximum number of consecutive paging messages of a first type the UE fails to receive before the second type of paging function is started. For example, the process 1100 may configure the maxFailedLegacyPagingOccasions parameter, described above, to the UE.

The process 1100 may configure (at block 1115) a third parameter to the UE, the third parameter indicating a maximum number of consecutive paging messages of a second type the UE fails to receive before the second type of paging function is stopped. For example, the process 1100 may configure the maxFailedRobustPagingOccasions parameter, described above, to the UE.

In some embodiments, the first, second, and third parameters may be configured to the UE at the time of manufacturing the UE. In some embodiments, the process 1100 may receive the first, second, and third parameters prior to starting the paging function of the second type through either an RRC message, a NAS message, a SIB message, or a MAC CE message.

The process 1100 may monitor (at block 1120), during the paging function of the first type, a paging occasion of the first type to receive a paging message of the first type. For example, the process 1100 may be monitoring, during the legacy paging function, a legacy paging occasion to receive a legacy paging message.

At block 1125, the process 1100 may, after failing to receive the paging message of the first type during the paging occasion of the first type, increment the number of consecutive paging occasions of the first type the UE fails to receive paging messages of the first type. For example, the process 1100 may increment the Failed_Legacy_Paging_Occasions variable described above, after failing to receive the legacy paging message during the legacy paging occasion.

The process 1100 may determine (at block 1130) that the number of consecutive paging occasions of the first type the UE fails to receive the paging messages of the first type has reached a value of the second parameter. For example, the process 1100 may determine that the value of the Failed_Legacy_Paging_Occasions variable has reached the value of the second parameter (e.g., the maxFailedRobustPagingOccasions).

The process 1100 may start (at block 1135) the second type of paging function after determining that (i) the value of the first parameter indicates that the UE is allowed to start the second type of paging function, and (ii) the number of consecutive paging occasions of the first type the UE fails to receive the paging messages of the first type has reached the value of the second parameter. For example, the process 1100 may determine that the value of the enableRobustPagingFunction parameter is set to True and the value of the Failed_Legacy_Paging_Occasions variable has reached the value of the second parameter (e.g., the maxFailedRobustPagingOccasions.

The process 1100 may monitor (at block 1140), during the second type of paging function, a paging occasion of the second type to receive a paging message of the second type. For example, the process 1100 may during the robust paging function, a robust paging occasion to receive a robust paging message. The process 1100 may then end.

In should be noted that the UE may use the same paging occasion or a different paging occasion. If the UE uses a different paging occasion, the UE may use a different formula to determine a paging occasion for the robust paging. For example, just adding a subframe offset to the result of the legacy paging occasion may be used to determine the robust paging occasion.

Further, if different paging occasions are used, then the UE may wake up at the legacy paging occasion and at the robust paging occasion. In either case of waking up at the same or different paging occasions, the UE may receive the robust paging message via PDSCH resources that are dedicated to the robust paging message. The BS may allocate different PDSCH resources to carry the different message data types. For robust paging, this may be accomplished via the robust paging DCI, as the information carried in that DCI may point to a set of PDSCH resource that carries the robust paging message.

In some embodiments, when a paging message of the second type is received by the UE, the process 1100 may retrieve a message identity index from the paging message of the second type and may retrieve a string identified by the message identity index. The UE may include a display and the process 1100 may display the string identified by the message identity on the display of the UE.

If the UE fails to receive a paging message of the second type during the paging occasion of the second type, the process 1100 may increment the number of consecutive paging occasions of the second type during which the UE fails to receive paging messages of the second type (e.g., the variable Failed_Robust_Paging_Occasions, described above). The process 1100 may stop the paging function of the second type when the number of consecutive paging occasions of the second type during which the UE fails to receive the paging messages of the second type reaches a value of the third parameter. For example, the process 1100 may stop the robust paging function when the number of consecutive robust paging occasions during which the UE fails to receive the robust paging messages reaches the value of the third parameter (e.g., the maxFailedRobustPagingOccasions parameter).

In some embodiments, the UE may be further configured with a fourth parameter indicating whether the UE supports concurrent monitoring of the paging messages of the first and second types. For example, the UE may be configured with the contLegacyPagingWhileRobustPaging parameter, described above. In these embodiments, the process 1100 may concurrently monitor for the paging messages of the first and second types when the paging function of the second type is started, and the fourth parameter indicates that the UE supports the concurrent monitoring of the paging messages of the first and second types.

The process 1100 may then monitor for the paging messages of the first type and not monitor for the paging messages of the second type when either a paging message of the first type is received, a paging message of the second type is received, or the number of consecutive paging occasions of the second type during which the UE fails to receive the paging messages of the second type reaches the value of the third parameter. For example, the process 1100 may transition from the third state 303 to the second state 302, as described above with reference to FIG. 3.

When the UE is configured with the fourth parameter (e.g., the contLegacyPagingWhileRobustPaging parameter) indicating whether the UE supports concurrent monitoring of the paging messages of the first and second types, the process 1100 may monitor for the paging messages of the second type and not monitor for the paging messages of the first type when the paging function of the second type is started, and the fourth parameter indicates that the UE does not support the concurrent monitoring of the paging messages of the first and second types.

The process 1100 may then monitor for the paging messages of the first type and not monitor for the paging messages of the second type when either a paging message of the second type is received, or the number of consecutive paging occasions of the second type during which the UE fails to receive the paging messages of the second type reaches the value of the third parameter. For example, the process 1100 may transition from the fourth state 304 to the second state 302, as described above with reference to FIG. 3.

In some embodiments, the process 1100 may receive a DCI message that includes a fourth parameter indicating the number of times a paging message of the second type is retransmitted during each paging occasion of the second type. For example, the process 1100 may receive the parameter robustPageRepetitionNumber, described above. The process 1100 may identify several second type of paging messages that are retransmitted during the paging occasion of the second type based on the fourth parameter and may aggregate a correctly decoded part of each of two or more paging messages of the second type that are retransmitted during the paging occasion of the second type to construct a fully decoded paging message of the second type.

In some embodiments, the UE may be further configured with a fourth parameter indicating the number of times a paging message of the second type is to be retransmitted during each paging occasion of the second type. For example, the UE may be configured with the robustPageRepetitionNumber-r20 parameter, described above. The fourth parameter may be configured to the UE either at the time of manufacturing the UE or through either an RRC message, a NAS message, a SIB message, or a MAC CE message. The process 1100 may identify several paging messages of the second type that are retransmitted during the paging occasion of the second type based on the fourth parameter and may aggregate a correctly decoded part of each of two or more paging messages of the second type that are retransmitted during the paging occasion of the second type to construct a fully decoded paging message of the second type.

In some embodiments, the UE may be further configured with a 5G-S-TMSI. The process 1100 may retrieve a second type of 5G-S-TMSI from each paging message of the second type. The process 1100 may compare the first type of 5G-S-TMSI with the second type of 5G-S-TMSI and may determine that the paging message of the second type is targeted to the UE when the second type of 5G-S-TMSI is equal to the first type of 5G-S-TMSI.

In some embodiments, the first type of 5G-S-TMSI may include m bits, where m is a non-zero integer. The process 1100 may retrieve a second type of 5G-S-TMSI from each paging message of the second type. The second type of 5G-S-TMSI may include n bits, where n is a non-zero integer smaller than m. The process 1100 may compare the second type of 5G-S-TMSI with the first n-bits of the first type of 5G-S-TMSI. The process 1100 may determine that the paging message of the second type is targeted to the UE when the second type of 5G-S-TMSI is equal to the first n-bits of the first type of 5G-S-TMSI.

In some embodiments, the paging messages of the first type are identified by a RNTI of the first type. The RNTI of the first type may be a paging RNTI (P-RNTI). The paging messages of the second type may identified by a RNTI of the second type that is different from the P-RNTI. In some embodiments, each paging message of the first type may be received in a first PDSCH. The first PDSCH may be identified by a DCI message of the first type. A CRC of each DCI message of the first type may be encoded with the P-RNTI. Each paging message of the second type may be received in a second PDSCH. The second PDSCH may be identified by a DCI message of the second type. A CRC of each DCI message of the second type is encoded with the RNTI of the second type. In these embodiments, the process 1100 may identify a DCI message as a DCI message of the first type that includes a paging message of the first type when the CRC of the DCI message is decoded by the P-RNTI. The process 1100 may identify a DCI message as a DCI message of the second type comprising a paging message of the second type in a case that the CRC of the DCI message is decoded by the RNTI of the second type.

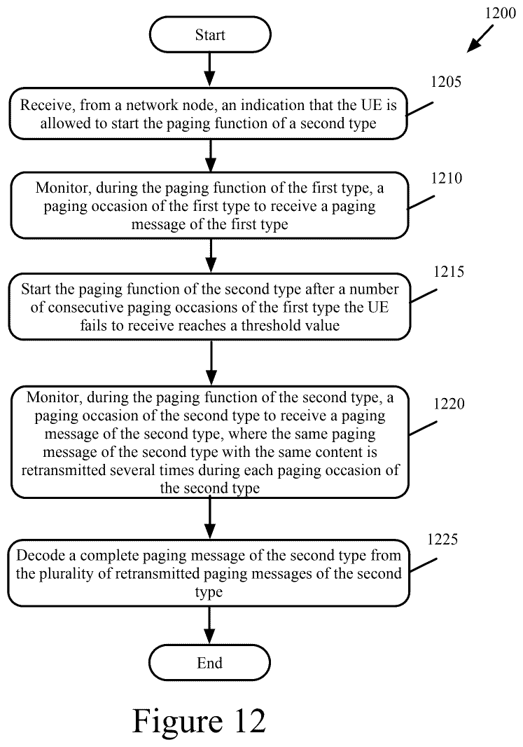

FIG. 12 is a flowchart illustrating an example method/process 1200 performed by a UE for configuring the UE to support paging functions of first and second types, according to an example implementation of the present disclosure. The process 1200, in some embodiments, may be performed by at least one processor of a UE such as the UE 120 shown in FIG. 1 or the UEs 201A-201C shown in FIG. 2. The first type may be legacy paging and the second type may be robust paging.

The process 1200 may receive (at block 1205), from a network node, an indication that the UE is allowed to start the paging function of a second type. For example, the process 1200 may receive the enableRobustPagingFunction parameter with its value set to True. The process 1200 may monitor (at block 1210), during the paging function of the first type, a paging occasion of the first type to receive a paging message of the first type. For example, the UE may be in the second state 302 of FIG. 3, where the robust paging is enabled but the UE is still monitoring for the legacy paging messages as the other conditions for the monitoring for the robust paging are not satisfied yet. Each paging message of the first type may be transmitted multiple times. Each paging message of the first type has a different content form other messages of the first type that are transmitted in the same occasion.

7. The process 1200, in some embodiments, may receive the indication that the UE is allowed to start the paging function of the second type by receiving a MIB from the network. The MIB may include a field that indicates whether the UE is allowed to start the paging function of the second type. The filed, in some embodiments, may include only one bit of information.

The process 1200 may start (at block 1215) the paging function of the second type after the number of consecutive paging occasions of the first type the UE fails to receive reaches a threshold value. For example, the process 1200 may start the robust paging function after the number of consecutive legacy paging occasions that the UE fails to receive reaches a threshold value (e.g., the value of the maxFailedLegacyPagingOccasion parameter).

The process 1200 may monitor (at block 1220), during the paging function of the second type, a paging occasion of the second type to receive a paging message of the second type, where the same paging message of the second type with the same content is retransmitted several times during each paging occasion of the second type. For example, the process 1200 may monitor, during the robust paging function, a robust paging occasion to receive a robust paging message. The network retransmits the same robust paging message with the same content several times during each robust paging occasion. Retransmitting the same message content several times during the same robust paging occasion provides the technical advantage of allowing the UE to aggregate different parts of a robust paging message from different retransmitted robust paging messages.

The process 1200 may decode (at block 1225) a complete paging message of the second type from several retransmitted paging messages of the second type. The process 1200 may then end. The process 1200, in some embodiments, may decode the complete paging message of the second type by decoding at least one paging message of the second type from the retransmitted paging messages of the second type. For example, the process 1200 may be able to completely decode at least one of the several retransmitted robust paging messages.

Each of the several retransmitted paging messages of the second type may include several parts. for example, each robust paging message may include several parts that may be decoded separately. The process 1200 may determine that at least one part of each of several retransmitted paging messages of the second type is not decoded. The process 1200 may decode the complete paging message of the second type by aggregating one or more decoded parts of each of two or more paging messages of the retransmitted paging messages of the second type to construct the complete paging message of the second type. For example, the process 1200 may decode the complete robust paging message by aggregating one or more decoded parts of each of two or more retransmitted robust paging messages to construct the complete robust paging message.

The process 1200, in some embodiments, may receive a DCI message that includes a parameter indicating the number of times a paging message of the second type is retransmitted during each paging occasion of the second type. For example, the process 1200 may receive the robustPageRepetitionNumbe parameter, described above. The process 1200 may decode the complete paging message of the second type by identifying two or more of the retransmitted paging messages of the second type based on the parameter and decoding the complete paging message of the second type from the identified paging messages of the second type.

In some embodiments the UE may be configured with a parameter indicating the number of times a paging message of the second type may be retransmitted during each paging occasion of the second type. For example, the process 1200 may receive the robustPageRepetitionNumber-r20 parameter, described above. The parameter may be configured to the UE either at a time of manufacturing the UE or through either an RRC message, a NAS message, a SIB message, or a MAC CE message. The process 1200 may decode the complete paging message of the second by identifying the retransmitted paging messages of the second type based on the parameter and decoding the complete paging message of the second type from the identified paging message of the second type.

Each paging message of the first type may include several records. Each record may include the identity of a different UE. Each paging message of the second type may include only one paging record that includes an identity of only one UE.

The UE may be configured with a first type of 5G-S-TMSI. The identity of the UE in the paging record of a paging message of the second type may include a second type of 5G-S-TMSI (e.g., a robust-5G-S-TMSI). The process 1200 may receive a paging message of the second type during the paging function of the second type. The process 1200 may retrieve the second type of 5G-S-TMSI from the paging message of the second type. The process 1200 may compare the first type of 5G-S-TMSI with the second type of 5G-S-TMSI. The process 1200 may determine that the paging message of the second type is targeted to the UE when the second type of 5G-S-TMSI is equal to the first type of 5G-S-TMSI. The identity of each UE in the several records of a paging message of the first type includes the first type of 5G-S-TMSI configured to the UE.

The first type of 5G-S-TMSI, in some embodiments, may include m bits, where m is a non-zero integer. The identity of the UE in the paging record of a paging message of the second type, in some embodiments, may include a second type of 5G-S-TMSI that may include n bits, where n is a non-zero integer smaller than m. The process 1200 may receive a paging message of the second type during the paging function of the second type. The process 1200 may retrieve the second type of 5G-S-TMSI from the paging message of the second type. The process 1200 may compare the second type of 5G-S-TMSI with a first n-bits of the first type of 5G-S-TMSI. The process 1200 may determine that the paging message of the second type is targeted to the UE when the second type of 5G-S-TMSI is equal to the first n-bits of the first type of 5G-S-TMSI. The network may change the value of n to control the number of bits used to address the UE via the paging function of the second type.

In some embodiments, each paging message of the first type may be received in a first PDSCH. The first PDSCH may be identified by a DCI message of the first type. A CRC of each DCI message of the first type may be encoded with the P-RNTI. Each paging message of the second type may be received in a second PDSCH. The second PDSCH may be identified by a DCI message of the second type. A CRC of each DCI message of the second type is encoded with the RNTI of the second type. In these embodiments, the process 1200 may identify a DCI message as a DCI message of the first type that includes a paging message of the first type when the CRC of the DCI message is decoded by the P-RNTI. The process 1200 may identify a DCI message as a DCI message of the second type comprising a paging message of the second type in a case that the CRC of the DCI message is decoded by the RNTI of the second type.

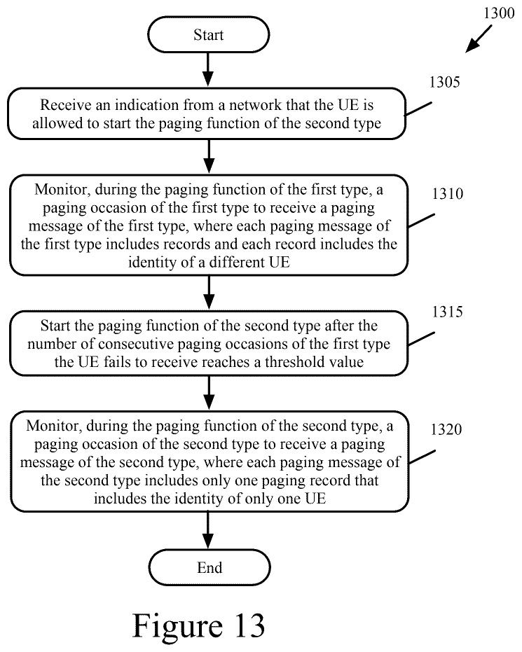

FIG. 13 is a flowchart illustrating an example method/process 1300 performed by a UE for configuring the UE to support paging functions of first and second types, according to an example implementation of the present disclosure. The process 1300, in some embodiments, may be performed by at least one processor of a UE such as the UE 120 shown in FIG. 1 or the UEs 201A-201C shown in FIG. 2. The first type may be legacy paging and the second type may be robust paging.

The process 1300 may receive (at block 1305) an indication from a network that the UE is allowed to start the paging function of the second type. For example, the process 1200 may receive the enableRobustPagingFunction parameter with its value set to True. The process 1300 may receive the indication in an MIB from the network. The MIB may include a field indicating whether the UE is allowed to start the paging function of the second type.

The process 1300 may monitor (at block 1310), during the paging function of the first type, a paging occasion of the first type to receive a paging message of the first type, where each paging message of the first type includes records, and each record includes the identity of a different UE. For example, the UE may be in the second state 302 of FIG. 3, where the robust paging is enabled but the UE is still monitoring for the legacy paging messages as the other conditions for the monitoring for the robust paging are not satisfied yet.

The process 1300 may start (at block 1315) the paging function of the second type after the number of consecutive paging occasions of the first type the UE fails to receive reaches a threshold value. For example, the process 1300 may start the robust paging function after the number of consecutive legacy paging occasions that the UE fails to receive reaches a threshold value (e.g., the value of the maxFailedLegacyPagingOccasion parameter).

The process 1300 may monitor (at block 1320), during the paging function of the second type, a paging occasion of the second type to receive a paging message of the second type, where each paging message of the second type includes only one paging record that includes the identity of only one UE. For example, the process 1300 may monitor, during the robust paging function, a robust paging occasion to receive a robust paging message, where each robust paging message includes only one record that includes the identity of only one UE. The process 1300 may then end.

The UE, in some embodiments, may be configured with a first type of 5G-S-TMSI. The first type of 5G-S-TMSI may uniquely identify the UE in a tracking area. The identity of the UE in the paging record of a paging message of the second type may include a second type of 5G-S-TMSI. The process 1300 may receive a paging message of the second type during the paging function of the second type. The process 1300 may retrieve the second type of 5G-S-TMSI from the paging message of the second type. The process 1300 may compare the first type of 5G-S-TMSI with the second type of 5G-S-TMSI and may determine that the paging message of the second type is targeted to the UE when the second type of 5G-S-TMSI is equal to the first type of 5G-S-TMSI.

The first type of 5G-S-TMSI, in some embodiments, may include m bits, where m is a non-zero integer. The identity of the UE in the paging record of a paging message of the second type may include a second type of 5G-S-TMSI that may include n bits, where n is a non-zero integer smaller than m. The process 1300, in these embodiments, may receive a paging message of the second type during the paging function of the second type. The process 1300 may retrieve the second type of 5G-S-TMSI from the paging message of the second type. The process 1300 may compare the second type of 5G-S-TMSI with a first n-bits of the first type of 5G-S-TMSI and may determine that the paging message of the second type is targeted to the UE when the second type of 5G-S-TMSI is equal to the first n-bits of the first type of 5G-S-TMSI. The network may change the value of n to control the number of bits used to address the UE via the paging function of the second type.

The paging messages of the first type, in some embodiments, may be identified by a RNTI. of the first type The RNTI of the first type may be a P-RNTI. The paging messages of the second type may be identified by a RNTI of the second type that is different from the P-RNTI. In some embodiments, each paging message of the first type may be received in a first PDSCH. The first PDSCH may be identified by a DCI message of the first type. A CRC of each DCI message of the first type may be encoded with the P-RNTI. Each paging message of the second type may be received in a second PDSCH. The second PDSCH may be identified by a DCI message of the second type. A CRC of each DCI message of the second type is encoded with the RNTI of the second type.

In these embodiments, the process 1300 may identify a DCI message as a DCI message of the first type that includes a paging message of the first type when the CRC of the DCI message is decoded by the P-RNTI. The process 1300 may identify a DCI message as a DCI message of the second type comprising a paging message of the second type in a case that the CRC of the DCI message is decoded by the RNTI of the second type.

The P-RNTI may be configured to the UE at the time of manufacturing the UE. The process 1300 may receive a paging message of the second type during the paging function of the second type and may retrieve the RNTI of the second type from the paging message of the second type.

The paging records of the paging messages of the second type, in some embodiments, may include a message identity index. The process 1300 may receive a paging message of the second type during the paging function of the second type. The process 1300 may retrieve the message identity index from the paging message of the second type and may retrieve a string identified by the message identity index. The process 1300 may display the string identified by the message identity on the display of the UE. The message identity index may correspond to the caller ID of another UE that started a call, or sent a SMS message, to the UE.

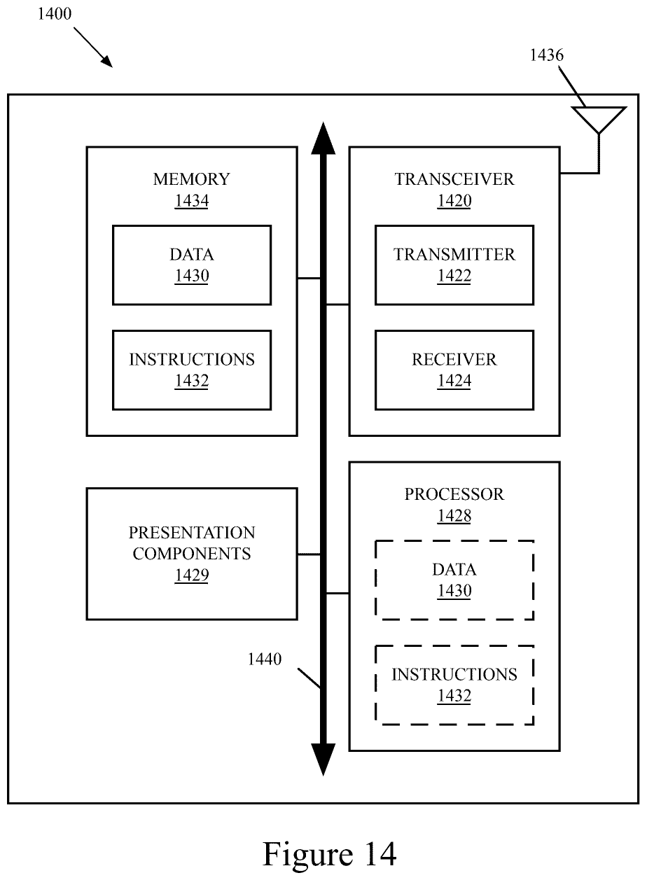

FIG. 14 is a block diagram illustrating a node 1400 for wireless communication, according to an example implementation of the present disclosure. As illustrated in FIG. 14, a node 1400 may include a transceiver 1420, a processor 1428, a memory 1434, one or more presentation components 1429, and at least one antenna 1436. The node 1400 may also include a radio frequency (RF) spectrum band module, a BS communications module, a network communications module, and a system communications management module, Input/Output (I/O) ports, I/O components, and a power supply (not illustrated in FIG. 14).

Each of the components may directly or indirectly communicate with each other over one or more buses 1440. The node 1400 may be a UE, a BS, a LMF server, or any other network node on the RAN side or CN side that performs various functions disclosed with reference to FIGS. 1 through 10.

The transceiver 1420 has a transmitter 1422 (e.g., transmitting/transmission circuitry) and a receiver 1424 (e.g., receiving/reception circuitry) and may be configured to transmit and/or receive time and/or frequency resource partitioning information. The transceiver 1420 may be configured to transmit in different types of subframes and slots including, but not limited to, usable, non-usable, and flexibly usable subframes and slot formats. The transceiver 1420 may be configured to receive data and control channels.

The node 1400 may include a variety of computer-readable media. Computer-readable media may be any available media that may be accessed by the node 1400 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1434 may include computer-storage media in the form of volatile and/or non-volatile memory. The memory 1434 may be removable, non-removable, or a combination thereof. Example memory may include solid-state memory, hard drives, optical-disc drives, etc. As illustrated in FIG. 14, the memory 1434 may store a computer-readable and/or computer-executable instructions 1432 (e.g., software codes) that are configured to, when executed, cause the processor 1428 to perform various functions disclosed herein, for example, with reference to FIGS. 1 through 10. Alternatively, the instructions 1432 may not be directly executable by the processor 1428 but may be configured to cause the node 1400 (e.g., when compiled and executed) to perform various functions disclosed herein.

The processor 1428 (e.g., having processing circuitry) may include an intelligent hardware device, e.g., a Central Processing Unit (CPU), a microcontroller, an ASIC, etc. The processor 1428 may include memory. The processor 1428 may process the data 1430 and the instructions 1432 received from the memory 1434, and information transmitted and received via the transceiver 1420, the baseband communications module, and/or the network communications module. The processor 1428 may also process information to send to the transceiver 1420 for transmission via the antenna 1436 to the network communications module for transmission to a CN.

One or more presentation components 1429 may present data indications to a person or another device. Examples of presentation components 1429 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions for configuring the UE with different types of paging functions, wherein the UE is configured with:
a first parameter indicating whether the UE is allowed to start a paging function of a second type that is different from a paging function of a first type,
a second parameter indicating a maximum number of consecutive paging messages of the first type the UE has to fail to receive before the paging function of the second type is started, and
a third parameter indicating a maximum number of consecutive paging messages of a second type the UE has to fail to receive before the paging function of the second type is stopped; and
at least one processor coupled to the one or more non-transitory computer-readable media, and configured to execute the one or more computer-executable instructions to cause the UE to:
monitor, during the paging function of the first type, a paging occasion of the first type to receive a paging message of the first type;
after failing to receive the paging message of the first type during the paging occasion of the first type, increment a number of consecutive paging occasions of the first type the UE fails to receive paging messages of the first type;
determine that the number of consecutive paging occasions of the first type the UE fails to receive the paging messages of the first type has reached a value of the second parameter;
start the paging function of the second type after determining that (i) a value of the first parameter indicates that the UE is allowed to start the paging function of the second type, and (ii) the number of consecutive paging occasions of the first type the UE fails to receive the paging messages of the first type has reached the value of the second parameter; and
monitor, during the paging function of the second type, a paging occasion of the second type to receive a paging message of the second type.

2. The UE of claim 1, wherein the at least one processor is further configured to execute the one or more computer-executable instructions to cause the UE to:
in a case that a paging message of the second type is received by the UE:
retrieve a message identity index from the paging message of the second type, and
retrieve a string identified by the message identity index; and
in a case that the UE fails to receive a paging message of the second type during the paging occasion of the second type:
increment a number of consecutive paging occasions of the second type during which the UE fails to receive paging messages of the second type, and
stop the paging function of the second type in a case that the number of consecutive paging occasions of the second type during which the UE fails to receive the paging messages of the second type reaches a value of the third parameter.

3. The UE of claim 2, further comprising:
a display,
wherein the at least one processor is further configured to execute the one or more computer-executable instructions to cause the UE to:
display the string identified by the message identity on the display of the UE.

4. The UE of claim 1, wherein:
the UE is further configured with a fourth parameter indicating whether the UE supports concurrent monitoring of the paging messages of the first and second types, and
the at least one processor is further configured to execute the one or more computer-executable instructions to cause the UE to:
concurrently monitor for the paging messages of the first and second types in a case that the paging function of the second type is started, and the fourth parameter indicates that the UE supports the concurrent monitoring of the paging messages of the first and second types.

5. The UE of claim 4, wherein the at least one processor is further configured to execute the one or more computer-executable instructions to cause the UE to:
monitor for the paging messages of the first type and not monitor for the paging messages of the second type in a case that either a paging message of the first type is received, a paging message of the second type is received, or the number of consecutive paging occasions of the second type during which the UE fails to receive the paging messages of the second type reaches the value of the third parameter.

6. The UE of claim 1, wherein:
the UE is further configured with a fourth parameter indicating whether the UE supports concurrent monitoring of the paging messages of the first and second types, and
the at least one processor is further configured to execute the one or more computer-executable instructions to cause the UE to:
monitor for the paging messages of the second type and not monitor for the paging messages of the first type in a case that the paging function of the second type is started, and the fourth parameter indicates that the UE does not support the concurrent monitoring of the paging messages of the first and second types.

7. The UE of claim 6, wherein the at least one processor is further configured to execute the one or more computer-executable instructions to cause the UE to:
monitor for the paging messages of the first type and not monitor for the paging messages of the second type in a case that either a paging message of the second type is received, or the number of consecutive paging occasions of the second type during which the UE fails to receive the paging messages of the second type reaches the value of the third parameter.

8. The UE of claim 1, wherein the at least one processor is further configured to execute the one or more computer-executable instructions to cause the UE to:
receive a downlink control information (DCI) message comprising a fourth parameter indicating a number of times a paging message of the second type is retransmitted during each paging occasion of the second type;
identify a plurality of paging messages of the second type that are retransmitted during the paging occasion of the second type based on the fourth parameter; and
aggregate a correctly decoded part of each of two or more paging messages of the plurality of paging messages of the second type that are retransmitted during the paging occasion of the second type to construct a fully decoded paging message of the second type.

9. The UE of claim 1, wherein:
the UE is configured with a fourth parameter indicating a number of times a paging message of the second type is to be retransmitted during each paging occasion of the second type,
the fourth parameter is configured to the UE either at a time of manufacturing the UE or through one of a radio resource control (RRC) message, a non-access-stratum (NAS) message, a system information block (SIB) message, or a medium access control (MAC) control element (CE) message, and
the at least one processor is further configured to execute the one or more computer-executable instructions to cause the UE to:
identify a plurality of paging messages of the second type that is retransmitted during a paging occasion of the second type based on the fourth parameter; and
aggregate a correctly decoded part of each of two or more paging messages of the plurality of paging messages of the second type that is retransmitted during the paging occasion of the second type to construct a fully decoded paging message of the second type.

10. The UE of claim 1, wherein the first, second, and third parameters are configured to the UE at a time of manufacturing the UE.

11. The UE of claim 1, wherein the at least one processor is further configured to execute the one or more computer-executable instructions to cause the UE to:
receive the first, second, and third parameters prior to starting the paging function of the second type through one of a radio resource control (RRC) message, a non-access-stratum (NAS) message, a system information block (SIB) message, or a medium access control (MAC) control element (CE) message.

12. The UE of claim 1, wherein:
the UE is further configured with a first type of 5^{th} generation serving temporary mobile subscriber identity (5G-S-TMSI), and
the at least one processor is further configured to execute the one or more computer-executable instructions to cause the UE to:
retrieve a second type of 5G-S-TMSI from each paging message of the second type;
compare the first type of 5G-S-TMSI with the second type of 5G-S-TMSI; and
determine that the paging message of the second type is targeted to the UE when the second type of 5G-S-TMSI is equal to the first type of 5G-S-TMSI.

13. The UE of claim 1, wherein:
the UE is further configured with a first type of 5^{th} generation serving temporary mobile subscriber identity (5G-S-TMSI), the first type of 5G-S-TMSI comprising m bits, m being a non-zero integer, and
the at least one processor is further configured to execute the one or more computer-executable instructions to cause the UE to:
retrieve a second type of 5G-S-TMSI from each paging message of the second type, the second type of 5G-S-TMSI comprising n bits, n being a non-zero integer smaller than m;
compare the second type of 5G-S-TMSI with a first n-bits of the first type of 5G-S-TMSI; and
determine that the paging message of the second type is targeted to the UE when the second type of 5G-S-TMSI is equal to the first n-bits of the first type of 5G-S-TMSI.

14. The UE of claim 1, wherein:
the paging messages of the first type are identified by a radio network temporary identifier (RNTI) of the first type,
the RNTI of the first type is a paging RNTI (P-RNTI),
the paging messages of the second type are identified by RNTI of the second type that is different from the P-RNTI,
each paging message of the first type is received in a first physical downlink shared channel (PDSCH),
the first PDSCH is identified by a downlink control information (DCI) message of the first type,
a cyclic redundancy check (CRC) of each DCI message of the first type is encoded with the P-RNTI,
each paging message of the second type is received in a second PDSCH,
the second PDSCH is identified by a DCI message of the second type,
a CRC of each DCI message of the second type is encoded with the RNTI of the second type, and
the at least one processor is further configured to execute the one or more computer-executable instructions to cause the UE to:
identify a DCI message as a DCI message of the first type comprising a paging message of the first type in a case that the CRC of the DCI message is decoded by the P-RNTI; and
identify a DCI message as a DCI message of the second type comprising a paging message of the second type in a case that the CRC of the DCI message is decoded by the RNTI of the second type.

15. A method of configuring a user equipment (UE) with different types of paging functions, the method comprising:
configuring a first parameter to the UE, the first parameter indicating whether the UE is allowed to start a paging function of a second type that is different from a paging function of a first type;
configuring a second parameter to the UE, the second parameter indicating a maximum number of consecutive paging messages of a first type the UE fails to receive before the paging function of the second type is started;
configuring a third parameter indicating a maximum number of consecutive paging messages of a second type the UE fails to receive before the paging function of the second type is stopped;
monitoring, during the paging function of the first type, a paging occasion of the first type to receive a paging message of the first type;
after failing to receive the paging message of the first type during the paging occasion of the first type, incrementing a number of consecutive paging occasions of the first type the UE fails to receive paging messages of the first type;
determining that the number of consecutive paging occasions of the first type the UE fails to receive the paging messages of the first type has reached a value of the second parameter;
starting the paging function of the second type of after determining that (i) a value of the first parameter indicates that the UE is allowed to start the paging function of the second type of, and (ii) the number of consecutive paging occasions of the first type the UE fails to receive the paging messages of the first type has reached the value of the second parameter; and
monitoring, during the paging function of the second type of, a paging occasion of the second type to receive a paging message of the second type.
